(19) United States
(12) Patent Application Publication
(10) Pub. No.: US 2025/0153404 A1
(43) Pub. Date: May 15, 2025

(54) PROCESSING APPARATUS FOR VACUUM HEAT-INSULATING PLATE, AEROGEL-MODIFIED POLYURETHANE FOAM THERMAL INSULATION PLATE, AND PREPARATION METHOD THEREFOR

(71) Applicants: CHONGQING ZAISHENG TECHNOLOGY CO., LTD, Chongqing (CN); CHONGQING FIBER RESEARCH AND DESIGN INSTITUTE CO., LTD, Chongqing (CN)

(72) Inventors: Ziwei WANG, Chongqing (CN); Ying ZENG, Chongqing (CN)

(73) Assignees: CHONGQING ZAISHENG TECHNOLOGY CO., LTD, Chongqing (CN); CHONGQING FIBER RESEARCH AND DESIGN INSTITUTE CO., LTD, Chongqing (CN)

(21) Appl. No.: 18/836,367

(22) PCT Filed: Dec. 28, 2022
(86) PCT No.: PCT/CN2022/142998

§ 371 Date: Aug. 7, 2024

(30) Foreign Application Priority Data
Apr. 2, 2022 (CN) 202210350058.3
Jun. 20, 2022 (CN) 202210697817.3

(51) Int. Cl. B29C 44/12; B29C 31/00; B29C 44/56; B29K 75/00; B29K 105/00; B29L 7/00; B32B 3/04; B32B 5/02; B32B 5/18; B32B 15/09; B32B 15/14; B32B 15/20; B32B 27/08; B32B 27/32; B32B 27/36; B65G 15/20; B65G 23/44; B65H 35/06; B65H 37/04; B65H 37/06; F16L 59/065

(52) U.S. Cl. CPC B29C 44/1266; B29C 31/008; B29C 44/5681; B32B 3/04; B32B 5/02; B32B 5/18; B32B 15/09; B32B 15/14; B32B 15/20; B32B 27/08; B32B 27/322; B32B 27/36; B65G 15/20; B65H 35/06; B65H 37/04; B65H 37/06; F16L 59/065; B29K 2075/00; B29K 2105/0026; B29L 2007/002; B32B 2262/101; B32B 2264/108; B32B 2266/0278; B32B 2266/126; B32B 2307/304; B32B 2307/3065; B32B 2307/7242; B32B 2607/00; B65G 23/44; B65G 2201/022; B65H 2301/44322

(57) ABSTRACT

A processing apparatus for a vacuum heat-insulating plate, an aerogel-modified polyurethane foam thermal insulation plate, and a preparation method therefor are disclosed. The processing apparatus includes a first frame, a conveying mechanism disposed on the first frame, two edge-pulling mechanisms arranged as mirror images on the two sides of the conveying mechanism, two adhesive tape machines arranged as mirror images on the two sides of the conveying mechanism, and an edge-folding mechanism disposed above the conveying mechanism. The edge-pulling mechanisms, the edge-folding mechanism, and the adhesive tape machines are sequentially arranged along the conveying direction of the conveying mechanism. The aerogel-modified polyurethane foam thermal insulation plate of the present invention includes a polyurethane foam core and at least one thermal insulation pack, the polyurethane foam wraps the thermal insulation pack, and the volume ratio of the thermal insulation pack in the thermal insulation plate is 10%-90%.

### CROSS REFERENCE TO THE RELATED APPLICATIONS

This application is the national phase entry of International Application No. PCT/CN2022/142998, filed on Dec. 28, 2022, which is based upon and claims priority to Chinese Patent Applications No. 202210350058.3, filed on Apr. 2, 2022, and No. 202210697817.3, filed on Jun. 20, 2022, the entire contents of which are incorporated herein by reference.

### TECHNICAL FIELD

The present invention belongs to the technical fields of thermal insulation material processing and thermal insulation plates, and relates to a processing apparatus for a vacuum heat-insulating plate, an aerogel-modified polyurethane foam thermal insulation plate, and a preparation method therefor.

### BACKGROUND

A vacuum heat-insulating plate is an efficient heat-insulating and heat-preserving material which combines a vacuum heat-insulating principle with a conventional heat-preserving material. By taking fiberglass as a core layer material and a gas barrier composite film as a packaging bag, the vacuum heat-insulating plate is prepared by vacuumizing and packaging. As a vacuum degree in the plate is maximized and convection of a gas is reduced to achieve efficient heat insulation, compared with other materials, the vacuum heat-insulating plate has the advantages of a thin heat-preserving layer, small volume and light weight with an extremely low heat conductivity coefficient under the same requirements for the heat-preserving technology, thereby being applicable to products with relatively high energy-saving requirements and having greater technical and economic significance.

The packaging bag of the vacuum heat-insulating plate is mostly made of an aluminum-containing composite material, and there is residual concavo-convex packaging bag on two sides of the vacuum heat-insulating plate after vacuumizing. If the packaging bag on the two sides of the vacuum heat-insulating plate is folded at edges for use without being completely straightened, a relatively large gap between plates which are spliced will be caused subsequently, and a thermal bridge will be formed, so that the thermal performance of the thermal insulation layer may be weakened to some extent. Therefore, it is necessary to straighten the concavo-convex packaging bag manually, then fold edges of the redundant packaging bag, and finally adhere an adhesive tape on the packaging bag manually for use. This whole process may consume a large amount of manpower, thereby being low in efficiency, and high in costs.

Building plates refer to isolation structures for commercial and residential use, and are generally composite plates taking fiberglass or polyurethane foam as base materials. Rigid polyurethane foam is a high-molecular polymer prepared by taking isocyanate and polyether as main raw materials, and mixing the main raw materials through special equipment under the action of a plurality of auxiliaries such as a foaming agent, a catalyst, and a flame retardant by means of high-pressure spraying and on-site forming. Polyurethane has good thermal insulation performance, and generally the polyurethane foam building plate on the market has a heat conductivity coefficient of 0.022-0.024 W/m·K, and is light in weight, non-corrosive and easy to cut. Through chemical modification, the polyurethane foam building plate may also have excellent flame retardancy, smoke diffusion resistance and mechanical properties. However, the thermal insulation performance of the existing polyurethane foam building plate cannot meet the high requirements for the thermal insulation performance in some occasions. Due to the demands for heat preservation in winter, thermal insulation in summer, fire prevention and flame retardance, there is a need for building plates with better thermal insulation performance in the building industry; and there is also a need for thermal insulation plates with more excellent thermal insulation performance and flame retardancy in the fields of petroleum or natural gas refineries, chemical plants, automobiles, electric multiple unit (EMU) trains, ship hulls, aerospace, and the like. By modifying the polyurethane foam, the heat conductivity coefficient of the polyurethane foam is decreased as much as possible without affecting the flame retardancy, so as to meet the high requirements for the building plates in the above fields.

Aerogel is a porous ultralight material, and is generally prepared by a sol-gel process. The aerogel is an outstanding heat-insulating body which generally contains 98% of air, and has an extremely small pore size of 10-40 nanometers. The aerogel, such as silica aerogel, is hydrophilic in nature, since the aerogel possesses a sponge-like nanostructure, and ice-sized aerogel has a surface area which is equivalent to half a soccer field and large enough to adsorb many water molecules; in addition, a surface of the aerogel structure is covered with oxygen and hydrogen groups which may adsorb the water molecules; and the aerogel may be hydrophobic and moisture resistant through chemical treatment.

### SUMMARY

In view of the above problems in the prior art, an object of the present invention is to provide a processing apparatus for a vacuum heat-insulating plate which may achieve automatic edge-pulling, edge-folding and adhesive tape adhering, and an aerogel-modified polyurethane foam thermal insulation plate having a low heat conductivity coefficient and a long service life.

The object of the present invention may be achieved by the following technical solutions.

The processing apparatus for a vacuum heat-insulating plate includes a first frame, a conveying mechanism disposed on the first frame, two edge-pulling mechanisms arranged as mirror images on two sides of the conveying mechanism, two adhesive tape machines arranged as mirror images on the two sides of the conveying mechanism, and an edge-folding mechanism disposed above the conveying mechanism, wherein the edge-pulling mechanisms, the edge-folding mechanism, and the adhesive tape machines are sequentially arranged along a conveying direction of the conveying mechanism.

The conveying mechanism is used for conveying the vacuum heat-insulating plate forwards, the edge-pulling mechanisms are used for straightening a packaging bag at an edge of the vacuum heat-insulating plate, the edge-folding mechanism is used for folding the packaging bag at the edge of the vacuum heat-insulating plate, and the adhesive tape machines are used for adhering an adhesive tape on the vacuum heat-insulating plate.

The two edge-pulling mechanisms are arranged as mirror images, so as to ensure balanced stress of the vacuum heat-insulating plate during edge-pulling, and the two adhesive tape machines arranged as mirror images may adhere adhesive tapes on two sides of the vacuum heat-insulating plate simultaneously, so as to replace a manual operation mode in the prior art, thereby saving manpower, improving efficiency, and reducing costs.

In the above processing apparatus for a vacuum heat-insulating plate, the conveying mechanism includes a conveyor belt support, two first synchronous wheels respectively disposed at two ends of the conveyor belt support, a conveyor belt tightened on the two first synchronous wheels, and a driving assembly for driving the conveyor belt to convey forwards, and the edge-pulling mechanisms are disposed on the conveyor belt support.

The two first synchronous wheels are disposed in parallel and are rotatable around a central axis thereof, the driving assembly drives one of the first synchronous wheels to rotate, and the other first synchronous wheel is driven to rotate synchronously by the conveyor belt to achieve forward conveying of the conveyor belt.

In the above processing apparatus for a vacuum heat-insulating plate, a plurality of conveyor belt supports are disposed parallel to each other, two ends of each conveyor belt support are provided with the first synchronous wheels, each conveyor belt support is provided with one conveyor belt, and a plurality of conveyor belts are driven by the same driving assembly; and the first frame is provided with a plurality of first sliding rails parallel to each other, the first sliding rails are perpendicular to the conveyor belt supports, each conveyor belt support is provided with sliding blocks which are equal to the first sliding rails in number and are disposed in one-to-one correspondence with the first sliding rails, the sliding blocks are in sliding fit with the first sliding rails disposed corresponding to the sliding blocks, and the first frame is provided with an adjustment mechanism for adjusting a distance between the sliding blocks on the same first sliding rail.

The adjustment mechanism is used for adjusting the distance between the sliding blocks on the same first sliding rail, and when the distance between the sliding blocks on the same first sliding rail changes, a distance between the conveyor belt supports changes accordingly, so as to achieve the purpose of adjusting a width of the conveying mechanism, and enable the conveying mechanism to adapt to the vacuum heat-insulating plates with different widths.

In the above processing apparatus for a vacuum heat-insulating plate, the adjustment mechanism includes a plurality of first screw rods which are equal to the first sliding rails in number and are disposed in one-to-one correspondence with the first sliding rails, and an adjustment assembly for driving the first screw rods to rotate synchronously in a same direction, wherein the first screw rods are parallel to the first sliding rails, an adjustment nut is fixedly connected to at least one of the sliding blocks disposed on the same first sliding rail, and the adjustment nut is in threaded fit with the corresponding first screw rod.

When the adjustment assembly drives the first screw rod to rotate, the adjustment nut moves along a length direction of the first screw rod to drive the sliding block to slide, so as to achieve the purpose of adjusting the width of the conveying mechanism.

In the above processing apparatus for a vacuum heat-insulating plate, the first screw rod is provided with a first thread section and a second thread section, a direction of rotation of the first thread section is opposite to that of the second thread section, at least two of the sliding blocks disposed on the same first sliding rail are provided with adjustment nuts, and the first thread section and the second thread section are respectively in threaded fit with at least one adjustment nut.

When the first screw rod rotates, a direction of movement of the adjustment nut on the first thread section is opposite to that of the adjustment nut on the second thread section, so as to quickly adjust the width of the conveying mechanism.

In the above processing apparatus for a vacuum heat-insulating plate, the adjustment assembly includes engaging teeth disposed at one end of the first screw rod, a chain for connecting two engaging teeth which are adjacently disposed in a transmission way, and a first hand wheel for driving one of the first screw rods to rotate around a central axis thereof, wherein the engaging teeth are fixedly connected to the corresponding first screw rods coaxially and circumferentially.

When the first hand wheel rotates, the first screw rod is driven to rotate, the first screw rod drives other first screw rods to rotate through the engaging teeth and the chain, and a plurality of first screw rods rotate synchronously in a same direction, so as to ensure that changes in widths of various portions of the conveying mechanism are uniform.

In the above processing apparatus for a vacuum heat-insulating plate, a pillar extending downwardly is fixedly connected to a middle portion of the conveyor belt support, a second synchronous wheel is disposed at a lower end of the pillar, and the conveyor belt is tightened by the second synchronous wheel and the two first synchronous wheels.

The second synchronous wheel is parallel to the first synchronous wheels, and the conveyor belt is of a triangular structure after being tightened, so as to facilitate the mounting of the first screw rods on an inner side of the conveyor belt, and prevent the first screw rods from interfering with the conveyor belt.

In the above processing apparatus for a vacuum heat-insulating plate, the driving assembly includes a first motor fixed on the first frame and a rotary shaft rotatably fitted with the first frame, the rotary shaft is parallel to the first synchronous wheels, the first synchronous wheel positioned at one end of the conveyor belt support is slidably sleeved on the rotary shaft and is in circumferential limiting fit with the rotary shaft, and a motor shaft of the first motor is connected to the rotary shaft in a transmission way.

When the first motor works, the rotary shaft is driven to rotate around a center line thereof, so as to drive a plurality of first synchronous wheels sleeved on the rotary shaft to rotate. The motor shaft of the first motor is parallel to the rotary shaft, a first synchronous pulley is coaxially and fixedly connected to the motor shaft of the first motor, a second synchronous pulley is coaxially and fixedly connected to the rotary shaft, and the first synchronous pulley is connected to the second synchronous pulley in a transmission way through a synchronous belt.

In the above processing apparatus for a vacuum heat-insulating plate, the edge-pulling mechanism includes an edge-pulling support fixed on the conveyor belt support positioned on an outer side, and two edge-pulling assemblies distributed as mirror images on the edge-pulling support along a vertical direction, wherein the edge-pulling support is further provided with a guide assembly for guiding a packaging bag at the edge of the vacuum heat-insulating plate between the two edge-pulling assemblies.

In the above processing apparatus for a vacuum heat-insulating plate, the edge-pulling assembly includes a motor support, a second motor disposed on the motor support, and first edge-pulling wheels driven by the second motor, wherein the packaging bag is straightened forwards and outwards by the two first edge-pulling wheels arranged as mirror images on upper and lower sides.

A small gap exists or contact is formed between the first edge-pulling wheel positioned above and the first edge-pulling wheel positioned below, wherein a width of the small gap is less than a thickness of the packaging bag, and directions of rotation of the two first edge-pulling wheels are opposite. An included angle between an axis of the first edge-pulling wheel and the conveying direction of the conveyor belt is a with a value range of 30° to 60°. The conveyor belt drives the vacuum heat-insulating plate to be conveyed from rear to front, and in a horizontal direction, a distance between a front end of the first edge-pulling wheel and the conveyor belt is less than a distance between a rear end of the first edge-pulling wheel and the conveyor belt.

In the above processing apparatus for a vacuum heat-insulating plate, the motor support is further provided with second edge-pulling wheels driven by the second motor, an axis of the second edge-pulling wheel is parallel to that of the first edge-pulling wheel, directions of rotation of the first edge-pulling wheel and the second edge-pulling wheel are the same, and the packaging bag is straightened forwards and outwards by the two second edge-pulling wheels arranged as mirror images on upper and lower sides. An edge-pulling effect is enhanced under the combined action of the first edge-pulling wheels and the second edge-pulling wheels.

In the above processing apparatus for a vacuum heat-insulating plate, an outer layer of the first edge-pulling wheel is a soft layer, and an outer layer of the second edge-pulling wheel is a soft layer. As the packaging bag is relatively thin, the two first edge-pulling wheels are brought into contact and the two second edge-pulling wheels are brought into contact, so as to enhance a straightening effect. The soft layer may be made of rubber or silicone to increase a frictional force with the packaging bag.

In the above processing apparatus for a vacuum heat-insulating plate, an edge-pulling wheel carrier is fixed on the motor support, a first spline shaft, a second spline shaft and a third spline shaft which are parallel to each other and rotatable around central axes thereof are disposed in the edge-pulling wheel carrier in a penetrating way, the first edge-pulling wheels are coaxially fixed on the second spline shaft, the second edge-pulling wheels are coaxially fixed on the third spline shaft, the second spline shaft is in engagement with the first spline shaft, the third spline shaft is in engagement with the second spline shaft, and a motor shaft of the second motor is connected to the first spline shaft in a transmission way.

The second motor drives the first spline shaft to rotate, and the first spline shaft drives the second spline shaft and the third spline shaft to rotate simultaneously, so that the first edge-pulling wheel and the second edge-pulling wheel rotate in the same direction. The first edge-pulling wheel is positioned behind the second edge-pulling wheel, rotational speeds of the first edge-pulling wheel and the second edge-pulling wheel are the same, or the rotational speed of the second edge-pulling wheel is greater than that of the first edge-pulling wheel.

In the above processing apparatus for a vacuum heat-insulating plate, a first pulley is coaxially disposed on the motor shaft of the second motor, a second pulley is coaxially disposed on the first spline shaft, the first pulley is connected to the second pulley in a transmission way through a belt, and a tensioning structure for tensioning the belt is disposed on the motor support.

The tensioning structure is used for tensioning the belt to prevent slipping.

In the above processing apparatus for a vacuum heat-insulating plate, the motor support is provided with a mounting hole, the tensioning structure includes a tensioning block slidably connected in the mounting hole, a connecting shaft fixed on the tensioning block and a tensioning wheel rotatably connected on the connecting shaft, the belt is tensioned by the tensioning wheel, the first pulley and the second pulley, a first screw is in threaded connection with the motor support, and one end of the first screw is rotatably connected to the tensioning block.

An axis of the tensioning wheel is parallel to an axis of the first pulley, the tensioning wheel is positioned between the first pulley and the second pulley, a direction of extension of the first screw is perpendicular to the axis of the tensioning wheel, and a line connecting the first pulley and the second pulley is perpendicular to the first screw. When the first screw rotates, the tensioning block may be driven to slide horizontally in the mounting hole, thereby changing a position of the tensioning wheel to achieve the purpose of tensioning the belt.

In the above processing apparatus for a vacuum heat-insulating plate, the guide assembly includes an upper guide plate and a lower guide plate which are connected to the edge-pulling wheel carrier, and a distance between the upper guide plate and the lower guide plate gradually decreases along the conveying direction from rear to front; and the upper guide plate is provided with a first avoidance hole, the first edge-pulling wheel and the second edge-pulling wheel which are positioned above are positioned in the first avoidance hole, the lower guide plate is provided with a second avoidance hole, and the first edge-pulling wheel and the second edge-pulling wheel which are positioned below are positioned in the second avoidance hole.

In the above processing apparatus for a vacuum heat-insulating plate, a second frame is disposed on the first frame, two fixed side plates are arranged as mirror images on the second frame, two optical axes are disposed between the two fixed side plates perpendicular to the conveying direction, two adjustment plates arranged as mirror images are in sliding fit with the optical axes, the two adjustment plates are positioned between the two fixed side plates, second screw rods parallel to the optical axes are disposed on the two fixed side plates in a penetrating way, a second hand wheel is disposed at one end of the second screw rod, the second screw rod is provided with a third thread section and a fourth thread section, a direction of rotation of the third thread section is opposite to that of the fourth thread section, one of the adjustment plates is in threaded connection with the third thread section, the other adjustment plate is in threaded connection with the fourth thread section, two edge-folding mechanisms are arranged as mirror images between the conveyor belt support positioned on an outer side and the adjustment plates.

The two fixed side plates are arranged as mirror images on the two sides of the conveying mechanism, the two adjustment plates are arranged as mirror images on the two sides of the conveying mechanism, and the edge-folding mechanisms are arranged as mirror images on the two sides of the conveying mechanism. Two ends of the two optical axes are fixedly connected to different fixed side plates respectively, the second screw rods are rotatably fitted with the fixed side plates, and the second hand wheel rotates to drive the second screw rod to rotate, thereby changing the distance between the two adjustment plates to achieve the purpose of changing the distance between the two edge-folding mechanisms, so as to adapt to the vacuum heat-insulating plates with different widths.

In the above processing apparatus for a vacuum heat-insulating plate, the edge-folding mechanism includes an edge-blocking profile disposed on the conveyor belt support on the outer side, an edge-blocking plate disposed above the conveyor belt to be fixed relative to the fixed side plate, and an edge-folding guide plate disposed on the fixed side plate, wherein an inner side edge of the edge-folding guide plate is a bevel edge, the bevel edge extends from the conveying direction to a middle portion of the conveyor belt along an outer side of the conveyor belt, namely an acute angle is formed between the bevel edge and an edge of the conveyor belt, and when a packaging bag is in contact with the bevel edge, the packaging bag may be folded to an upper portion of the vacuum heat-insulating plate under the action of the bevel edge. The edge-blocking profile extends along the conveying direction and gradually increases in height from rear to front, and a maximum height of the edge-blocking profile is higher than an upper surface of the edge-folding guide plate.

Specifically, a first gap for the packaging bag internally provided with the vacuum heat-insulating plate to pass through is formed between the edge-blocking plate and the conveyor belt, a second gap for the packaging bag to pass through is formed between the edge-blocking profile and the edge-blocking plate, and a third gap for the packaging bag to pass through is formed between the edge-folding guide plate and the edge-blocking plate.

During work, the vacuum heat-insulating plate which is subjected to edge-pulling is conveyed between two edge-blocking profiles by the conveyor belt, the packaging bags on the two sides of the vacuum heat-insulating plate are gradually folded upwards under the action of the edge-blocking profiles, then enter the second gap and gradually contact the bevel edge of the edge-folding guide plate, and the packaging bags are folded inwards under the action of the bevel edge.

In the above processing apparatus for a vacuum heat-insulating plate, the edge-folding guide plate is provided with a first support positioned in front of the edge-blocking plate, the first support is provided with a first pressing wheel rotatable around a center line thereof and a third motor for driving the first pressing wheel to rotate, and an axis of the first pressing wheel is parallel to a plane on which the conveyor belt is positioned.

After the packaging bags are folded inwards by the edge-folding mechanism, edges are further pressed by the first pressing wheel, so as to ensure the flatness of the folded vacuum heat-insulating plate.

In the above processing apparatus for a vacuum heat-insulating plate, upper pressing mounting plates are fixed on the two optical axes, a plurality of pressing wheel assemblies are arranged at intervals on the upper pressing mounting plates, and the plurality of pressing wheel assemblies are sequentially arranged along the conveying direction. Pressure is applied to the vacuum heat-insulating plate by the pressing wheel assemblies to facilitate upward folding of the packaging bags on the two sides of the vacuum heat-insulating plate.

In the above processing apparatus for a vacuum heat-insulating plate, the pressing wheel assembly includes a second support and a second pressing wheel rotatably disposed on the second support, wherein the second pressing wheel extends along the conveying direction perpendicular to the conveyor belt, and the second support is in floating connection with the upper pressing mounting plates.

In the above processing apparatus for a vacuum heat-insulating plate, two guide rods parallel to each other are fixed on the second support, the upper pressing mounting plates are provided with guide holes formed in one-to-one correspondence with the guide rods, and the guide rods are in sliding fit with the corresponding guide holes.

In the above processing apparatus for a vacuum heat-insulating plate, a mounting plate is mounted on the conveyor belt support positioned on the outer side, a plurality of guide wheels having axes perpendicular to an upper surface of the conveyor belt are mounted on the mounting plate, and the plurality of guide wheels are sequentially arranged along the conveying direction of the conveyor belt.

In the above processing apparatus for a vacuum heat-insulating plate, sliding seats are respectively disposed at two ends of the fixed side plates, the sliding seats are in sliding fit with second sliding rails disposed on the second frame, and the second frame is provided with a height adjustment assembly for adjusting upper and lower heights of the fixed side plates.

The height of the fixed side plate may be adjusted according to the thickness of the vacuum heat-insulating plate.

In the above processing apparatus for a vacuum heat-insulating plate, the height adjustment assembly includes a top plate fixed on the second frame, a second screw rotatably fitted with the top plate, and a third hand wheel disposed on the second screw, wherein a lower end of the second screw is in threaded connection with the fixed side plates.

The second screw is in axial limiting connection with the top plate, and according to actual situations, four top plates may be disposed and are respectively positioned at four corners of the second frame, one second screw is rotatably connected to each top plate, and a lower end of each second screw is in threaded connection with the fixed side plate. The height of the fixed side plate may be adjusted by rotating the third hand wheel.

In the above processing apparatus for a vacuum heat-insulating plate, the adhesive tape machine includes a mounting rack disposed above the conveying mechanism, an adhesive tape wheel disposed on the mounting rack, and a sucker for sucking an adhesive tape, wherein an axis of the adhesive tape wheel extends along a width direction of the first frame, the adhesive tape led out by the adhesive tape wheel passes around the sucker from rear to front to be adhered to the vacuum heat-insulating plate, and the mounting rack is provided with a cutting assembly for cutting the adhesive tape positioned between the sucker and the vacuum heat-insulating plate.

The conveying mechanism extends along a length direction of the first frame, a back surface of the adhesive tape led out by the adhesive tape wheel passes around the sucker from rear to front, and an adhesive surface of the adhesive tape is adhered to an upper surface of the vacuum heat-insulating plate. The vacuum heat-insulating plate is conveyed forwards to continuously pull the adhesive tape to move forwards, and the adhesive tape is continuously adhered to the vacuum heat-insulating plate, so as to achieve the purpose of automatically adhering the adhesive tape.

In the above processing apparatus for a vacuum heat-insulating plate, the cutting assembly includes a second connecting rod, wherein one end of the second connecting rod is provided with a blade, and the other end thereof is hinged to the mounting rack, and a middle portion of the second connecting rod is provided with a driving structure for enabling the blade to cut downwards.

The blade is disposed perpendicular to a length direction of the second connecting rod, and when the second connecting rod is in a horizontal state, the blade extends perpendicularly downwards. When the adhesive tape needs to be cut, the driving structure drives the second connecting rod to rotate, so as to move the blade downwards, and the blade is in contact with and cuts the adhesive tape positioned between the sucker and the vacuum heat-insulating plate.

In the above processing apparatus for a vacuum heat-insulating plate, the driving structure includes a transverse support disposed above the second connecting rod, a first connecting rod having an upper end hinged to the transverse support, and a lifter for lifting the mounting rack up and down relative to the transverse support, wherein the first connecting rod is parallel to an axis of the adhesive tape wheel around a rotation center line of the transverse support, and a lower end of the first connecting rod is hinged to the middle portion of the second connecting rod.

The lifter drives the mounting rack to lift up and down, so as to drive one end of the second connecting rod away from the blade to move up and down, and when one end of the second connecting rod away from the blade moves up under the action of the lifter, the blade moves downwards to complete a cutting motion. Or the lifter drives the transverse support to lift up and down, so as to drive the middle portion of the second connecting rod to move up and down, and when the middle portion of the second connecting rod moves downwards under the action of the lifter, the blade moves downwards to complete the cutting motion.

In the above processing apparatus for a vacuum heat-insulating plate, a supporting plate is disposed above the conveying mechanism, the lifter includes a cylinder fixed on the supporting plate, the transverse support is fixed on the cylinder, and the mounting support is fixed on a piston rod of the cylinder.

The cylinder is an air cylinder or a hydraulic cylinder, preferably the air cylinder. The cylinder is inverted, and the piston rod extends out from a lower end of the cylinder. When the piston rod extends out, the mounting rack is driven to descend; and when the piston rod contracts, the mounting rack is driven to rise.

In the above processing apparatus for a vacuum heat-insulating plate, an upper end of the sucker is hinged to the mounting rack, a rotation center of the sucker rotating around the mounting rack is parallel to the axis of the adhesive tape wheel, the sucker has a suction surface in contact with the adhesive tape, and the suction surface is provided with a plurality of suction holes.

The sucker is internally hollow, one side opposite to the suction surface is provided with a gas suction port and a gas inlet, the gas suction port is connected to an external gas pumping apparatus, and the gas inlet is formed to effectively prevent the sucker from sucking the adhesive tape too tightly, and ensure that the adhesive tape may move together with the vacuum heat-insulating plate.

As the mounting rack is lifted up and down, the sucker has two states: in contact with or not in contact with the vacuum heat-insulating plate.

In the above processing apparatus for a vacuum heat-insulating plate, the mounting rack is provided with a baffle plate for preventing the adhesive tape from falling off the sucker, one side of the baffle plate facing the sucker is provided with an anti-adhesive coating, and the mounting rack is provided with a driving structure for driving the baffle plate to move below the sucker when the mounting rack rises.

After the mounting rack rises, the baffle plate moves below the sucker under the action of the driving structure, at this moment, one side of the baffle plate facing the sucker moves to a lower side of the suction surface and is disposed opposite to the suction surface, and the adhesive tape is pressed between the suction surface and one side of the baffle plate facing the sucker, so as to prevent the adhesive tape from falling off the sucker. When the mounting rack descends, the baffle plate is separated from the sucker.

In the above processing apparatus for a vacuum heat-insulating plate, the driving structure includes a third connecting rod which is hinged to the transverse support and extends downwards, and a fourth connecting rod hinged to a lower end of the third connecting rod, wherein a first rotary shaft parallel to the adhesive tape wheel is fixedly connected to a lower end of the fourth connecting rod, the first rotary shaft is rotatably disposed in the mounting rack in a penetrating way, a fifth connecting rod is fixedly connected to the first rotary shaft, and the baffle plate is fixedly connected to the fifth connecting rod.

A rotation center line of the fourth connecting rod rotating around the third connecting rod is parallel to the first rotary shaft, the first rotary shaft is parallel to the adhesive tape wheel, and when the mounting rack is lifted up and down, up-and-down movement of the mounting rack is converted into swinging movement of the fifth connecting rod around the first rotary shaft, so as to control the movement of the baffle plate.

In the above processing apparatus for a vacuum heat-insulating plate, a second rotary shaft coaxial with the first rotary shaft is rotatably disposed on the mounting rack in a penetrating way, the first rotary shaft is fixedly connected to the second rotary shaft through a connecting rod, a sixth connecting rod is fixedly connected to the second rotary shaft, and the baffle plate is fixedly connected to the sixth connecting rod. One end of the baffle plate is fixedly connected to the fifth connecting rod, and the other end thereof is fixedly connected to the sixth connecting rod, thereby improving the structural stability of the baffle plate.

In the above processing apparatus for a vacuum heat-insulating plate, a bottom plate is fixedly connected below the supporting plate, and the bottom plate is provided with an adhesive tape pressing wheel for pressing the adhesive tape on the vacuum heat-insulating plate and an elastic assembly for always pressing the adhesive tape pressing wheel on the vacuum heat-insulating plate.

The bottom plate is provided with an opening, and the adhesive tape pressing wheel is disposed in the opening. When the sucker is in contact with the vacuum heat-insulating plate, the sucker is positioned in the opening.

The elastic assembly always presses the adhesive tape pressing wheel on the vacuum heat-insulating plate, so as to improve an adhering effect of the adhesive tape and the vacuum heat-insulating plate, and a position of the adhesive tape pressing wheel may be adjusted up and down according to the thickness of the vacuum heat-insulating plate, so as to enable the adhesive tape to be adhered to the vacuum heat-insulating plates with different thicknesses. A portion of the adhesive tape positioned between the adhesive tape pressing wheel and the sucker is a tensioned portion in a tensioned state, and when the tensioned portion is cut by the cutting assembly, an avoidance phenomenon of the tensioned portion may not occur.

In the above processing apparatus for a vacuum heat-insulating plate, the elastic assembly includes two supporting seats fixed on the bottom plate and elastic members disposed in the supporting seats for pressing the adhesive tape pressing wheel downwards, wherein opposite sides of the two supporting seats are provided with sliding grooves extending up and down, two ends of a supporting shaft for supporting the adhesive tape pressing wheel respectively extend into the sliding grooves, and a lower end of the elastic member acts on the supporting shaft. The elastic member may be a spring which is pressed on the supporting shaft under the action of an elastic force, so that the adhesive tape pressing wheel is always pressed on the vacuum heat-insulating plate.

Compared with the prior art, the processing apparatus for a vacuum heat-insulating plate has the following advantages:

the two edge-pulling mechanisms are arranged as mirror images, so as to ensure balanced stress of the vacuum heat-insulating plate during edge-pulling, the packaging bag may be automatically folded by the edge-folding mechanism, and the two adhesive tape machines arranged as mirror images may adhere adhesive tapes on two sides of the vacuum heat-insulating plate simultaneously, so as to replace a manual operation mode in the prior art, thereby saving manpower, improving efficiency, and reducing costs; meanwhile, the distance between the two conveyor belt supports positioned on the outer side may be adjusted, so as to achieve the purpose of changing the width of the conveying mechanism, and enable the conveying mechanism to adapt to the vacuum heat-insulating plates with different widths, so that the applicable range is wide.

In order to achieve the object of the present invention, the following technical solution is also adopted.

An aerogel-modified polyurethane foam thermal insulation plate includes a polyurethane foam core and at least one thermal insulation pack, wherein the thermal insulation pack is disposed inside of the polyurethane foam core, polyurethane foam wraps the thermal insulation pack, and a volume ratio of the thermal insulation pack in the thermal insulation plate is 10%-90%, preferably 30-70%;

the thermal insulation pack includes an outer shell formed by enclosure of a barrier film having a gas barrier effect, the outer shell is filled with a thermal insulation material and at least one gas suction pack, the thermal insulation material includes 1-60 wt % of aerogel and 40-99 wt % of an inorganic fiber, preferably 15-60 wt % of aerogel and 40-85 wt % of an inorganic fiber, or 25-60 wt % of aerogel and 40-75 wt % of an inorganic fiber;

the gas suction pack is filled with metal oxide, the metal oxide includes calcium oxide, a set amount of the gas suction pack is determined according to an area of the thermal insulation pack, and the gas suction pack is controlled to be ≤5 g/m²; and

a heat conductivity coefficient of the thermal insulation pack is 0.001-0.010 w/m·k.

Preferably, the barrier film is an aluminum foil composite film, preferably a fiberglass cloth/AL/PET/CPE composite film or a fiberglass cloth/AL/PET/NY/CPE composite film;

an outer pack body of the gas suction pack is made of a material having waterproof and breathable properties, preferably a high-density polyethylene material, preferably Tyvek DuPont paper; and the outer pack body is filled with the metal oxide; and

the metal oxide further includes copper oxide, and cerium oxide; and a mass percentage of the calcium oxide in the metal oxide is 98-99.5%, the balance is the copper oxide and/or the cerium oxide, and the copper oxide and the cerium oxide are mixed in any ratio.

Preferably, the aerogel, the inorganic fiber, and the gas suction pack are sealed in the outer shell of the thermal insulation pack, and the outer shell is internally vacuumized and sealed to improve a thermal insulation effect; and

preferably, the polyurethane foam core is externally compounded with a decorative surface, and preferably, the decorative surface is a film, coated paper, a non-woven fabric, an aluminum film laminated veneer or a stainless steel frame body.

Preferably, the aerogel is selected from organic aerogel, polyimide aerogel or polyurethane aerogel, preferably silica aerogel; and the inorganic fiber is selected from one or a mixture of some of fiberglass, a basalt fiber and a ceramic fiber; and preferably, the polyurethane foam core contains a flame retardant.

Preferably, the thermal insulation material further includes a black material, and the black material is one or a mixture of some of carbon black, ferric oxide and trititanium pentoxide;

a specific surface area of the black material is 10-360 m²/g, preferably 70-150 m²/g;

a mass ratio of the black material in the thermal insulation material is 0%-10%, preferably 2-8% or 3-5%; and

an average particle size of the black material is ≤10 um.

Preferably, the thermal insulation material further includes other materials, wherein the other materials are selected from expanded perlite, precipitated silica, calcium carbonate, talcum powder or magnesium hydroxide; and

the thermal insulation pack or the gas suction pack is in a shape of a cuboid, a cube, a sphere or a cylinder.

The thermal insulation plate has a thickness of 0.6-10 cm, and the thermal insulation pack has a thickness of 0.49-0.98 cm, a heat conductivity coefficient of ≤0.015 w/m·k, a flame spread index of ≤30, and a smoke index of ≤300.

A preparation method for the above aerogel-modified polyurethane foam thermal insulation plate includes the steps of:
1) preparation of a thermal insulation pack: sealing a thermal insulation material and a gas suction pack in a barrier film to prepare the thermal insulation pack;
2) placing the thermal insulation pack in a thermal insulation plate preparation mold;
3) pouring liquid polyurethane foam into the thermal insulation plate preparation mold, and ensuring that the thermal insulation pack is completely wrapped by a foam material; and
4) hardening and sizing the foam material to form a final product.

In the above preparation method, the liquid polyurethane foam contains a flame retardant, and the flame retardant is a halogen flame retardant or a non-halogen flame retardant, preferably phosphotriester, diethyl hydroxyethyl phosphonate, triethyl phosphate, aluminum hydroxide, magnesium hydroxide or molybdenum oxide.

Preferably, the preparation method further includes step 5) decorating the thermal insulation plate, wherein the decorating includes coloring a surface and compounding a decorative surface on the surface, and preferably the decorative surface is a film, coated paper, a non-woven fabric, an aluminum film laminated veneer or a stainless steel frame body.

The thermal insulation pack is vacuumized and sealed to improve a thermal insulation effect. In a process of use, a small amount of gas may slowly penetrate into the thermal insulation pack through a gas barrier film, and a material sealed inside may also slowly release gas over time. When a vacuum degree in the thermal insulation pack gradually decreases, the heat conductivity coefficient may increase due to the brought air heat conduction effect, thereby reducing the thermal insulation effect of the thermal insulation plate. The gas suction pack may prolong a holding time of the vacuum degree of the thermal insulation pack, and increase a service life of the thermal insulation plate in a process of practical use.

The aerogel has porous and ultralight material properties, and generally contains 98% of air, thereby having a barrier effect on three pathways of heat conduction when being used in the thermal insulation pack. Air pores in the aerogel have small pore sizes, and air molecules in the air pores lose the ability of self-activity and are in an approximately vacuum condition, thereby reducing thermal transmission caused by convection. A large number of air pore walls obstruct heat radiation transmission, and lengthen a heat conduction path. Therefore, the use of aerogel in the polyurethane foam building plate may further reduce the heat conductivity coefficient of the thermal insulation plate.

The inorganic fiber provides a framework structure for the thermal insulation pack, so as to ensure the vacuum degree. A vacuum environment may reduce thermal transmission, thereby achieving the thermal insulation effect. The black material acts as a black body radiator and may be mixed with the aerogel to act as a radiation absorber, so as to reduce or inhibit heat or thermal energy transmission caused by radiation.

The present invention has the following beneficial effects: the thermal insulation plate of the present invention combines the advantages of the polyurethane foam building plate of being light in weight, non-corrosive and easy to cut; and by filling a barrier film protective outer shell with the aerogel and then wrapping in polyurethane foam, the polyurethane foam plate with the packaged aerogel exhibits a heat conductivity coefficient much lower than that of a conventional polyurethane foam plate with a similar construction, and has an excellent flame retardancy simultaneously. The polyurethane foam thermal insulation plate of the present invention are more suitable for use in thermal insulation structures, may be used in various thermal insulation applications, such as commercial and residential building isolation structures, and may also be used in the fields of petroleum or natural gas refineries, chemical plants, automobiles, electric multiple unit (EMU) trains, ship hulls, and aerospace.

### BRIEF DESCRIPTION OF THE DRAWINGS

FIG. 1 is a schematic view of a structure of an edge-folding apparatus provided by the present invention.

FIG. 2 is a schematic view of a structure of a conveying mechanism provided by the present invention.

FIG. 3 is a schematic view of mounting of two edge-pulling mechanisms provided by the present invention.

FIG. 4 is a schematic view of structures of the two edge-pulling mechanisms provided by the present invention.

FIG. 5 is a schematic view of a structure of a single edge-pulling mechanism provided by the present invention.

FIG. 6 is a schematic view of a partial structure of the single edge-pulling mechanism provided by the present invention.

FIG. 7 is a schematic view of a structure of a single edge-pulling assembly provided by the present invention.

FIG. 8 is a schematic view of a structure of an edge-pulling wheel carrier provided by the present invention.

FIG. 9 is a schematic view of an internal structure of the edge-pulling wheel carrier provided by the present invention.

FIG. 10 is a schematic view of mounting of an edge-folding mechanism provided by the present invention.

FIG. 11 is a schematic view of a structure of the edge-folding mechanism provided by the present invention.

FIG. 12 is a schematic view of a partial structure of the edge-folding mechanism provided by the present invention.

FIG. 13 is a schematic view of mounting of an adhesive tape machine provided by the present invention.

FIG. 14 is a schematic view of a structure of the adhesive tape machine provided by the present invention.

FIG. 15 is a side view of the adhesive tape machine provided by the present invention.

FIG. 16 is a schematic view of a partial structure of the adhesive tape machine provided by the present invention.

FIG. 17 is a schematic view of another partial structure of the adhesive tape machine provided by the present invention.

FIG. 18 is a schematic view of yet another partial structure of the adhesive tape machine provided by the present invention.

FIG. 19 is a schematic view of mounting of an adhesive tape pressing wheel provided by the present invention.

FIG. 20 is a schematic view of a structure of an aerogel-modified polyurethane foam thermal insulation plate of the present invention.

FIG. 21 is a schematic view of an internal structure of a thermal insulation pack in FIG. 20.

In the drawings, a. vacuum heat-insulating plate; 10. first frame; 11. conveying mechanism; 111. conveyor belt support; 112. first synchronous wheel; 113. conveyor belt; 1141. first sliding rail; 1142. sliding block; 1143. first screw rod; 1144. adjustment nut; 1145. engaging tooth; 1146. chain; 1147. first hand wheel; 115. pillar; 116. second synchronous wheel; 1171. first motor; 1172. rotary shaft; 12. edge-pulling mechanism; 121. edge-pulling support; 122. edge-pulling assembly; 1221. motor support; 12211. mounting hole; 1222. second motor; 1223. first edge-pulling wheel; 1224. second edge-pulling wheel; 1225. edge-pulling wheel carrier; 1226. first spline shaft; 1227. second spline shaft; 1228. third spline shaft; 12291. first pulley; 12292. second pulley; 12293. belt; 12294. tensioning block; 12295. tensioning wheel; 12296. first screw; 123. guide assembly; 1231. upper guide plate; 1232. lower guide plate; 13. adhesive tape machine; 131. mounting rack; 132. adhesive tape wheel; 133. sucker; 1341. second connecting rod; 1342. blade; 1343. transverse support; 1344. first connecting rod; 1345. lifter; 1346. supporting plate; 1347. baffle plate; 1348. third connecting rod; 1349. fourth connecting rod; 1350. first rotary shaft; 1351. fifth connecting rod; 1352. second rotary shaft; 1353. connecting rod; 1354. sixth connecting rod; 136. bottom plate; 137. adhesive tape pressing wheel; 1381. supporting seat; 1382. elastic member; 1383. sliding groove; 1384. supporting shaft; 14. edge-folding mechanism; 141. edge-blocking profile; 142. edge-blocking plate; 143. edge-folding guide plate; 144. first support; 145. first pressing wheel; 146. third motor; 15. second frame; 16. fixed side plate; 17. optical axis; 18. adjustment plate; 19. second screw rod; 20. second hand wheel; 21. upper pressing mounting plate; 221. second support; 222. second pressing wheel; 223. guide rod; 224. guide wheel; 23. sliding seat; 24. second sliding rail; 251. top plate; 252. second screw; 253. third hand wheel; 1. thermal insulation plate; 2. thermal insulation pack; 3. polyurethane foam core; 4. gas suction pack; and 5. thermal insulation material.

### DETAILED DESCRIPTION OF THE EMBODIMENTS

The technical solutions of the present invention will be further described below through specific examples with reference to accompanying drawings, but the present invention is not limited to these examples.

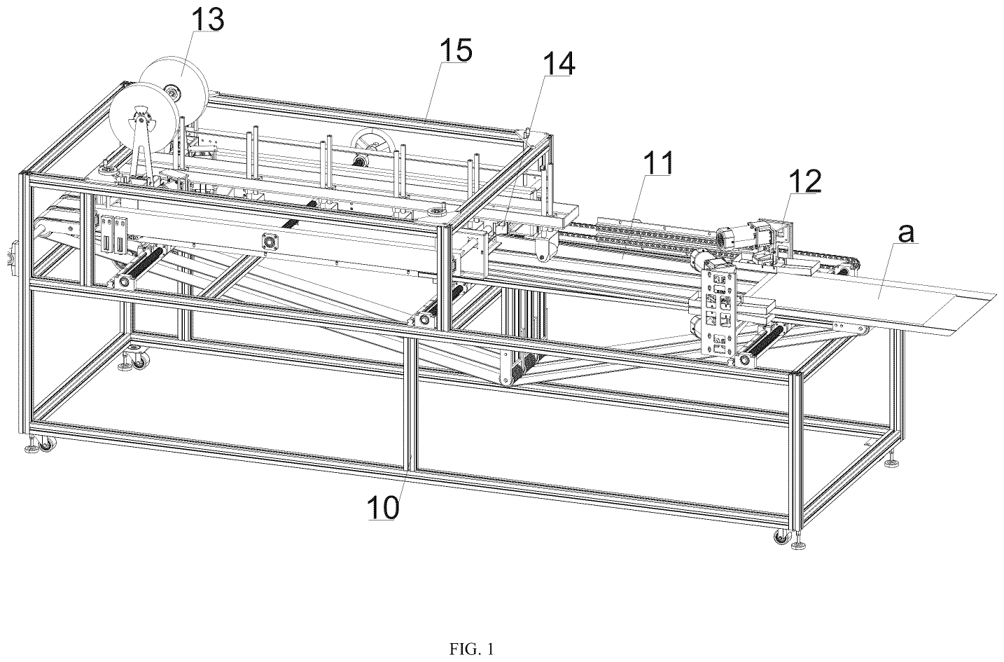

A processing apparatus for a vacuum heat-insulating plate as shown in FIG. 1 includes a first frame 10, a conveying mechanism 11 disposed on the first frame 10, two edge-pulling mechanisms 12 arranged as mirror images on two sides of the conveying mechanism 11, two adhesive tape machines 13 arranged as mirror images on the two sides of the conveying mechanism 11, and an edge-folding mechanism 14 disposed above the conveying mechanism 11, wherein the edge-pulling mechanisms 12, the edge-folding mechanism 14, and the adhesive tape machines 13 are sequentially arranged along a conveying direction of the conveying mechanism 11.

The conveying mechanism 11 extends along a front-rear direction for conveying the vacuum heat-insulating plate a forwards; the two edge-pulling mechanisms 12 are arranged as mirror images on left and right sides of the conveying mechanism 11 for straightening a packaging bag at an edge of the vacuum heat-insulating plate a; the two edge-folding mechanisms 14 are arranged as mirror images on the left and right sides of the conveying mechanism 11 for folding the packaging bag at the edge of the vacuum heat-insulating plate a; and the two adhesive tape machines 13 are arranged as mirror images on the left and right sides of the conveying mechanism 11 for adhering an adhesive tape on the vacuum heat-insulating plate a.

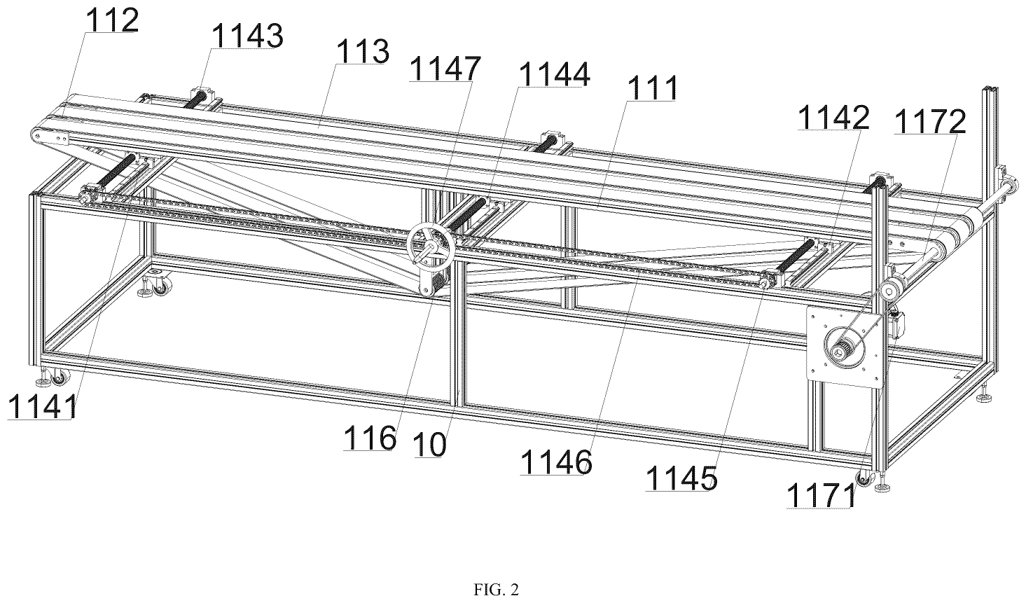

As shown in FIG. 2, the conveying mechanism 11 includes a conveyor belt support 111 extending horizontally along a length direction, two first synchronous wheels 112 respectively disposed at two ends of the conveyor belt support 111, a conveyor belt 113 tightened on the two first synchronous wheels 112, and a driving assembly for driving the conveyor belt 113 to convey forwards. The two first synchronous wheels 112 have axes extending horizontally along a left-right direction and are rotatable around central axes thereof, the driving assembly drives one of the first synchronous wheels 112 to rotate, and the other first synchronous wheel 112 is driven to rotate synchronously by the conveyor belt 113, so as to achieve forward conveying of the conveyor belt 113.

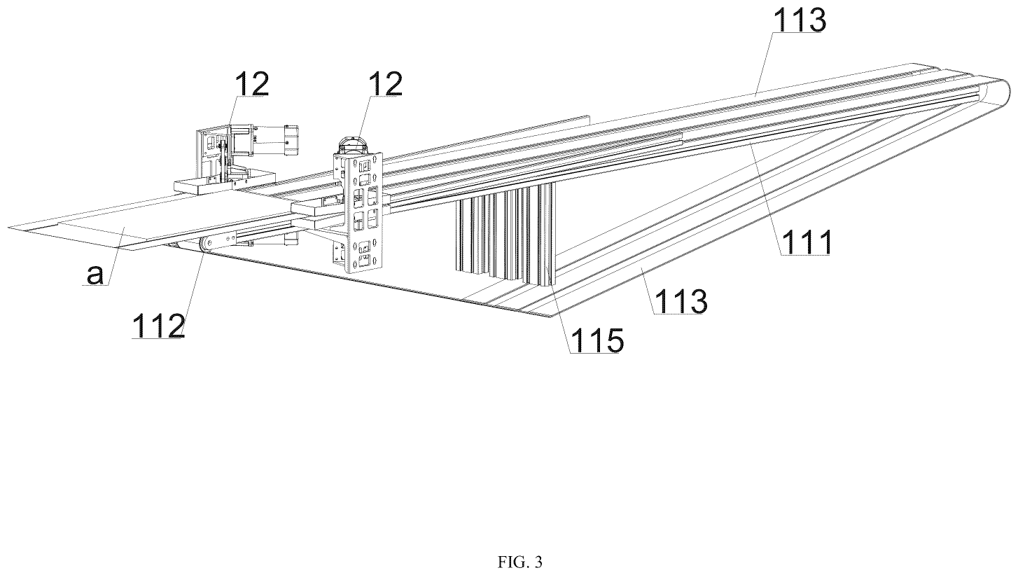

In this example, as shown in FIG. 2, three conveyor belt supports 111 are disposed parallel to each other, two ends of each conveyor belt support 111 are provided with the first synchronous wheels 112, each conveyor belt support 111 is provided with one conveyor belt 113, and a plurality of conveyor belts 113 are driven by the same driving assembly. In order to tension the conveyor belt 113, as shown in FIG. 2 and FIG. 3, a pillar 115 extending downwardly is fixedly connected to a middle portion of the conveyor belt support 111, a second synchronous wheel 116 is disposed at a lower end of the pillar 115, an axis of the second synchronous wheel 116 is parallel to that of the first synchronous wheel 112, and the conveyor belt 113 is tightened by the second synchronous wheel 116 and the two first synchronous wheels 112.

The purpose of disposing the three conveyor belt supports 111 is to adjust a width of the conveying mechanism 11, and in order to facilitate adjustment, as shown in FIG. 2, the first frame 10 is provided with three first sliding rails 1141 which are parallel to each other and extend horizontally along a left-right direction, the three first sliding rails 1141 are respectively positioned at two ends and the middle portion of the conveyor belt support 111, three sliding blocks 1142 which are disposed in one-to-one correspondence with the first sliding rails 1141 are fixed on each conveyor belt support 111, the sliding blocks 1142 are in sliding fit with the first sliding rails 1141 disposed corresponding to the sliding blocks 1142, and the first frame 10 is further provided with an adjustment mechanism for adjusting a distance between the two conveyor belt supports 111 positioned on outer sides to enable the conveyor belt supports 111 to adapt to the vacuum heat-insulating plates a with different widths.

In some other examples, two conveyor belt supports 111 are disposed, and the adjustment mechanism is used for adjusting a distance between two conveyor belts 113.

As shown in FIG. 2, the adjustment mechanism includes three first screw rods 1143 which are equal to the first sliding rails 1141 in number and are disposed in one-to-one correspondence with the first sliding rails 1141, and an adjustment assembly for driving the first screw rods 1143 to rotate synchronously in a same direction, wherein the first screw rods 1143 are parallel to the first sliding rails 1141, the two conveyor belt supports 111 positioned on the outer sides are respectively provided with three adjustment nuts 1144 disposed in one-to-one correspondence with the first screw rods 1143, and the adjustment nuts 1144 are in threaded fit with the corresponding first screw rods 1143.

When the adjustment assembly drives the first screw rods 1143 to rotate, the adjustment nuts 1144 move along a length direction of the first screw rods 1143 to drive the sliding blocks 1142 to slide, so as to achieve the purpose of adjusting the width of the conveying mechanism 11.

In some other examples, two first screw rods 1143 may be disposed.

In order to ensure that directions of movement of the two conveyor belt supports 111 positioned on the outer sides are opposite, the first screw rod 1143 is provided with a first thread section and a second thread section, and a direction of rotation of the first thread section is opposite to that of the second thread section, wherein one adjustment nut 1144 on the conveyor belt support 111 positioned on the outer side is in threaded fit with the first thread section, and the other adjustment nut 1144 on the conveyor belt support 111 positioned on the outer side is in threaded fit with the second thread section. When the first screw rod 1143 rotates, the direction of movement of adjustment nut 1144 on the first thread section is opposite to that of the adjustment nut 1144 on the second thread section, so as to quickly adjust the width of the conveying mechanism 11.

As shown in FIG. 2, the adjustment assembly includes engaging teeth 1145 disposed at one end of the first screw rod 1143, a chain 1146 for connecting two engaging teeth 1145 which are adjacently disposed in a transmission way, and a first hand wheel 1147 for driving one of the first screw rods to rotate around a central axis thereof, wherein the engaging teeth 1145 are fixedly connected to the corresponding first screw rods 1143 coaxially and circumferentially. When the first hand wheel 1147 rotates, the first screw rod 1143 is driven to rotate, the first screw rod 1143 drives other first screw rods 1143 to rotate through the engaging teeth 1145 and the chain 1146, and the three first screw rods 1143 rotate synchronously in a same direction, so as to ensure that changes in widths are uniform.

As shown in FIG. 2, the driving assembly includes a first motor 1171 fixed on the first frame 10 and a rotary shaft 1172 rotatably fitted with the first frame 10, the rotary shaft 1172 is parallel to the first synchronous wheels 112, the first synchronous wheel 112 positioned at one end of the conveyor belt support 111 is slidably sleeved on the rotary shaft 1172 and is in circumferential limiting fit with the rotary shaft 1172, and a motor shaft of the first motor 1171 is connected to the rotary shaft 1172 in a transmission way. When the rotary shaft 1172 rotates, the first synchronous wheel 112 positioned at one end of the conveyor belt support 111 may be driven to rotate. When the position between the two conveyor belt supports 111 on the outer sides changes, the first synchronous wheels 112 disposed on the two conveyor belt supports 111 slide on the rotary shaft 1172, wherein the first motor 1171 is a three-phase motor.

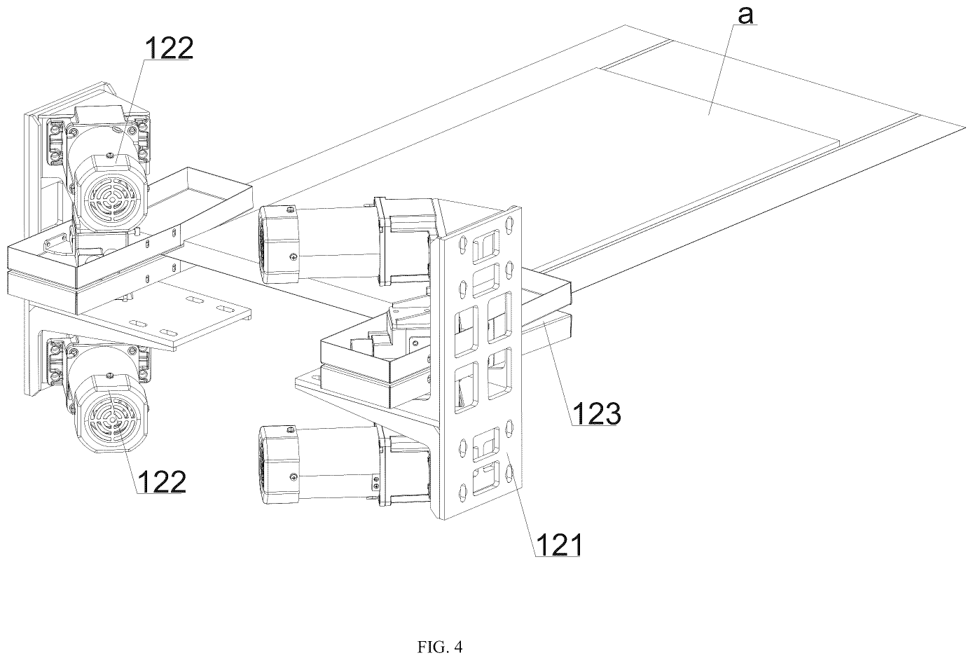

As shown in FIG. 3 and FIG. 4, the edge-pulling mechanism 12 includes two edge-pulling supports 121 respectively fixed on the conveyor belt supports 111 positioned on the outer sides, each edge-pulling support 121 is provided with two edge-pulling assemblies 122 distributed as mirror images along a vertical direction, and each edge-pulling support 121 is provided with a guide assembly 123 for guiding a packaging bag at the edge of the vacuum heat-insulating plate a between the two edge-pulling assemblies 122.

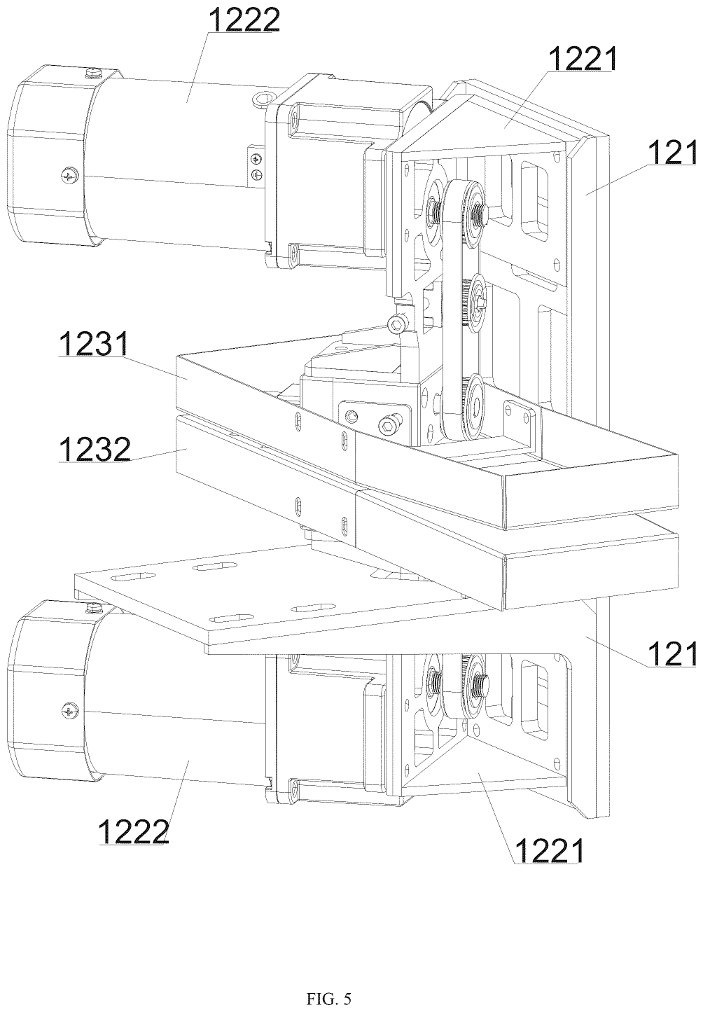

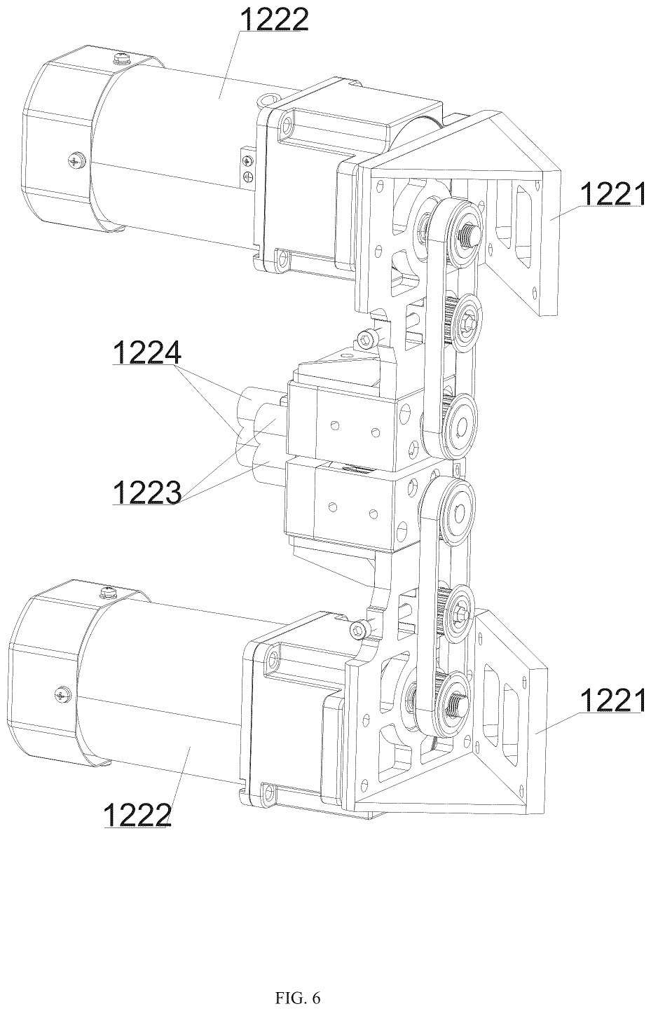

As shown in FIG. 5 and FIG. 6, the edge-pulling assembly 122 includes a motor support 1221, a second motor 1222 disposed on the motor support 1221, and first edge-pulling wheels 1223 driven by the second motor 1222, wherein the packaging bag is straightened forwards and outwards by the two first edge-pulling wheels 1223 arranged as mirror images on upper and lower sides positioned on two different edge-pulling assemblies 122 on upper and lower sides.

The second motor 1222 is a variable-speed motor, with a model of 5IK120RGU-CF.

A small gap exists or contact is formed between the first edge-pulling wheel 1223 positioned above and the first edge-pulling wheel 1223 positioned below, and contact is formed in this example, wherein a width of the small gap is less than a thickness of the packaging bag, and directions of rotation of the two first edge-pulling wheels 1223 are opposite.

A distance between an axis of the first edge-pulling wheel 1223 and the conveyor belt 113 gradually increases from front to rear along the conveying direction. An included angle between the axis of the first edge-pulling wheel and the conveying direction of the conveyor belt 113 is a with a value range of 30° to 60°. The conveyor belt 113 drives the vacuum heat-insulating plate a to be conveyed from rear to front, and in a horizontal direction, a distance between a front end of the first edge-pulling wheel 1223 and the conveyor belt 113 is less than a distance between a rear end of the first edge-pulling wheel 1223 and the conveyor belt 113.

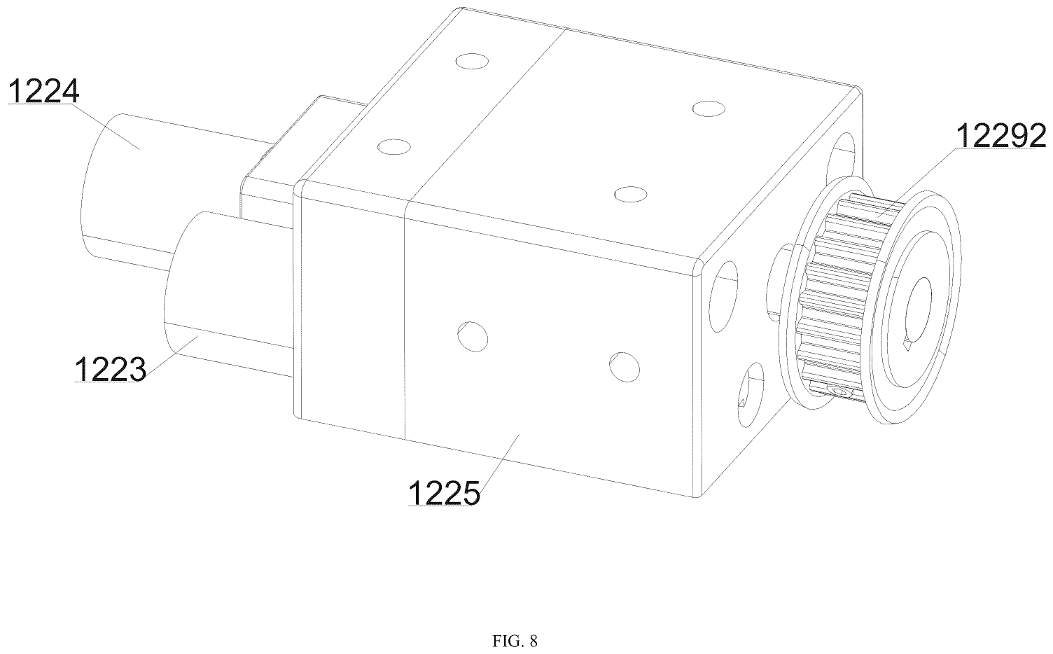

As shown in FIG. 6 and FIG. 8, the motor support 1221 is further provided with second edge-pulling wheels 1224 driven by the second motor 1222, an axis of the second edge-pulling wheel 1224 is parallel to that of the first edge-pulling wheel 1223, directions of rotation of the first edge-pulling wheel 1223 and the second edge-pulling wheel 1224 on the same edge-pulling assembly 122 are the same, and the packaging bag is straightened forwards and outwards by the two second edge-pulling wheels 1224 arranged as mirror images on upper and lower sides positioned on two different edge-pulling assemblies 122 on upper and lower sides.

In this example, an outer layer of the first edge-pulling wheel 1223 is a soft layer, and an outer layer of the second edge-pulling wheel 1224 is a soft layer.

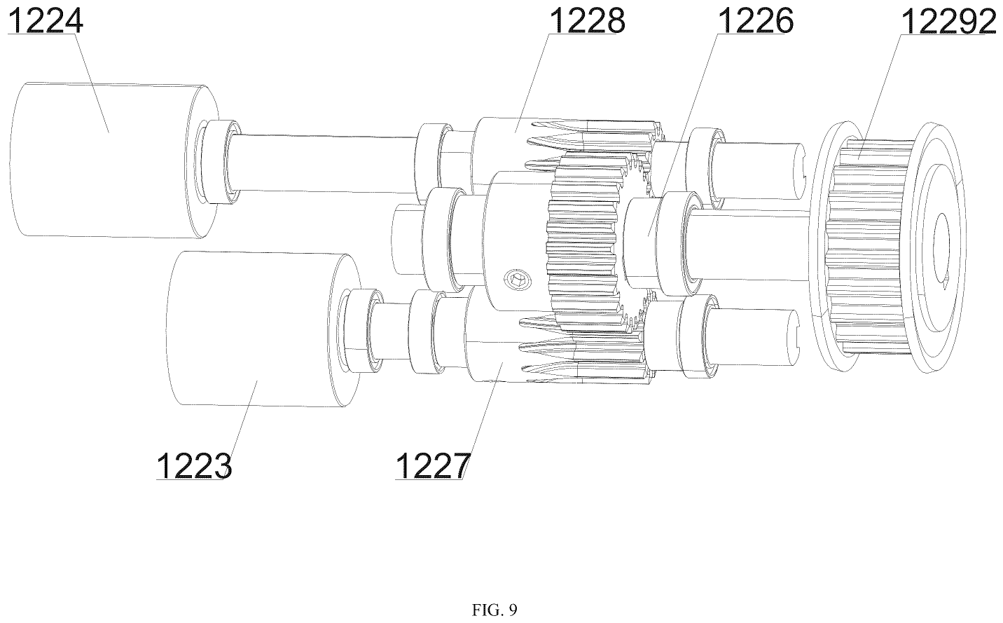

As shown in FIG. 9, an edge-pulling wheel carrier 1225 is fixed on the motor support 1221, a first spline shaft 1226, a second spline shaft 1227 and a third spline shaft 1228 which are parallel to each other and rotatable around central axes thereof are disposed in the edge-pulling wheel carrier 1225 in a penetrating way, the first edge-pulling wheels 1223 are coaxially fixed on the second spline shaft 1227, the second edge-pulling wheels 1224 are coaxially fixed on the third spline shaft 1228, the second spline shaft 1227 is in engagement with the first spline shaft 1226, the third spline shaft 1228 is in engagement with the second spline shaft 1227, and a motor shaft of the second motor 1222 is connected to the first spline shaft 1226 in a transmission way. The second motor 1222 drives the first spline shaft 1226 to rotate, and the first spline shaft 1226 drives the second spline shaft 1227 and the third spline shaft 1228 to rotate simultaneously, so that the first edge-pulling wheel 1223 and the second edge-pulling wheel 1224 rotate in the same direction. The first edge-pulling wheel 1223 is positioned behind the second edge-pulling wheel 1224, rotational speeds of the first edge-pulling wheel 1223 and the second edge-pulling wheel 1224 are the same, or the rotational speed of the second edge-pulling wheel 1224 is greater than that of the first edge-pulling wheel 1223.

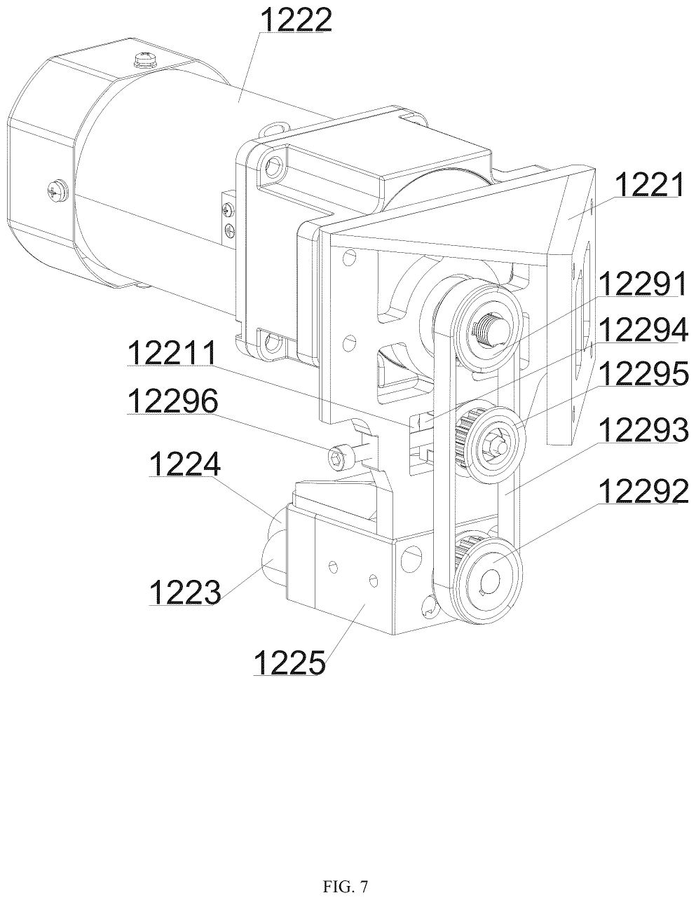

As shown in FIG. 7, a first pulley 12291 is coaxially disposed on the motor shaft of the second motor 1222, a second pulley 12292 is coaxially disposed on the first spline shaft 1226, the first pulley 12291 is connected to the second pulley 12292 in a transmission way through a belt 12293, and a tensioning structure for tensioning the belt 12293 is disposed on the motor support 1221. The tensioning structure is used for tensioning the belt 12293 to prevent slipping.

As shown in FIG. 7, the motor support 1221 is provided with a mounting hole 12211, the tensioning structure includes a tensioning block 12294 slidably connected in the mounting hole 12211, a connecting shaft fixed on the tensioning block 12294 and a tensioning wheel 12295 rotatably connected on the connecting shaft, the belt 12293 is tensioned by the tensioning wheel 12295, the first pulley 12291 and the second pulley 12292, a first screw 12296 is in threaded connection with the motor support 1221, and one end of the first screw 12296 is rotatably connected to the tensioning block 12294.

Wherein an axis of the tensioning wheel 12295 is parallel to an axis of the first pulley 12291, the tensioning wheel 12295 is positioned between the first pulley 12291 and the second pulley 12292, a direction of extension of the first screw 12296 is perpendicular to the axis of the tensioning wheel 12295, and a line connecting the first pulley 12291 and the second pulley 12292 is perpendicular to the first screw 12296. When the first screw 12296 rotates, the tensioning block 12294 may be driven to slide horizontally in the mounting hole 12211, thereby changing a position of the tensioning wheel 12295 to achieve the purpose of tensioning the belt 12293.

As shown in FIG. 5, the guide assembly 123 includes an upper guide plate 1231 and a lower guide plate 1232 which are connected to the edge-pulling wheel carrier 1225, and a distance between the upper guide plate 1231 and the lower guide plate 1232 gradually decreases from rear to front along the conveying direction. The vacuum heat-insulating plate a is conveyed forwards under the action of the conveyor belt 113, and the packaging bags on two sides of the vacuum heat-insulating plate a move between two edge-pulling assemblies 122 distributed as mirror image on upper and lower sides through the upper guide plate 1231 and the lower guide plate 1232, and the packaging bags are straightened under the combined action of the edge-pulling assemblies 122.

The upper guide plate 1231 is provided with a first avoidance hole, the first edge-pulling wheel 1223 and the second edge-pulling wheel 1224 which are positioned above are positioned in the first avoidance hole, the lower guide plate 1232 is provided with a second avoidance hole, and the first edge-pulling wheel 1223 and the second edge-pulling wheel 1224 which are positioned below are positioned in the second avoidance hole.

During work, the first motor 1171 and the second motor 1222 are started, the vacuum heat-insulating plate a is placed on the conveyor belt 113, after the packaging bags of the vacuum heat-insulating plate a are guided by the upper guide plate 1231 and the lower guide plate 1232, edge-pulling is performed by the first edge-pulling wheel 1223 and the second edge-pulling wheel 1224, and a tensile force is applied to the packaging bags on the two sides of the vacuum heat-insulating plate a by the first edge-pulling wheel 1223 and the second edge-pulling wheel 1224 to straighten the packaging bags on the two sides of the vacuum heat-insulating plate a.

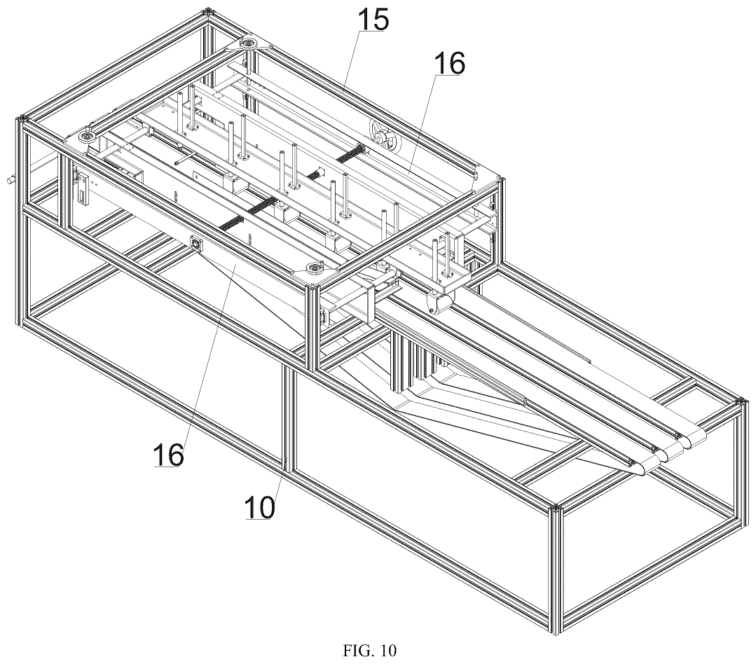

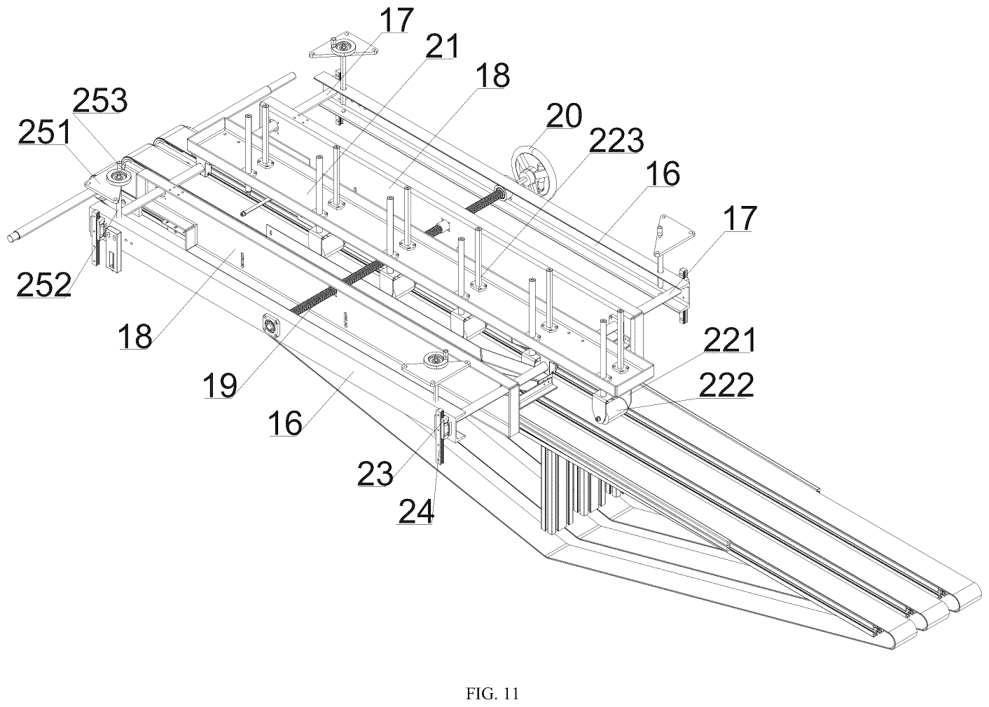

As shown in FIG. 1 and FIG. 10, a second frame 15 is disposed on the first frame 10. As shown in FIG. 11, two fixed side plates 16 are arranged as left and right mirror images on the second frame 15, two optical axes 17 are disposed between the two fixed side plates 16 perpendicular to the conveying direction, the optical axes 17 extend horizontally along the left-right direction, and two ends of the two optical axes 17 are fixedly connected to different fixed side plates 16 respectively.

Two adjustment plates 18 arranged as mirror images are in sliding fit with the optical axes 17, the two adjustment plates 18 are positioned between the two fixed side plates 16, second screw rods 19 parallel to the optical axes 17 are disposed on the two fixed side plates 16 in a penetrating way, two ends of the second screw rods 19 are rotatably fitted with the fixed side plates 16 respectively, a second hand wheel 20 is disposed at one end of the second screw rod 19, the second screw rod 19 is provided with a third thread section and a fourth thread section, a direction of rotation of the third thread section is opposite to that of the fourth thread section, one of the adjustment plates 18 is in threaded connection with the third thread section, the other adjustment plate 18 is in threaded connection with the fourth thread section, and two edge-folding mechanisms 14 are arranged as mirror images between the conveyor belt support 111 positioned on an outer side and the adjustment plates 18. The second hand wheel 20 rotates to drive the second screw rod 19 to rotate, thereby changing the distance between the two adjustment plates 18 to achieve the purpose of changing the distance between the two edge-folding mechanisms 14, so as to adapt to the vacuum heat-insulating plates a with different widths.

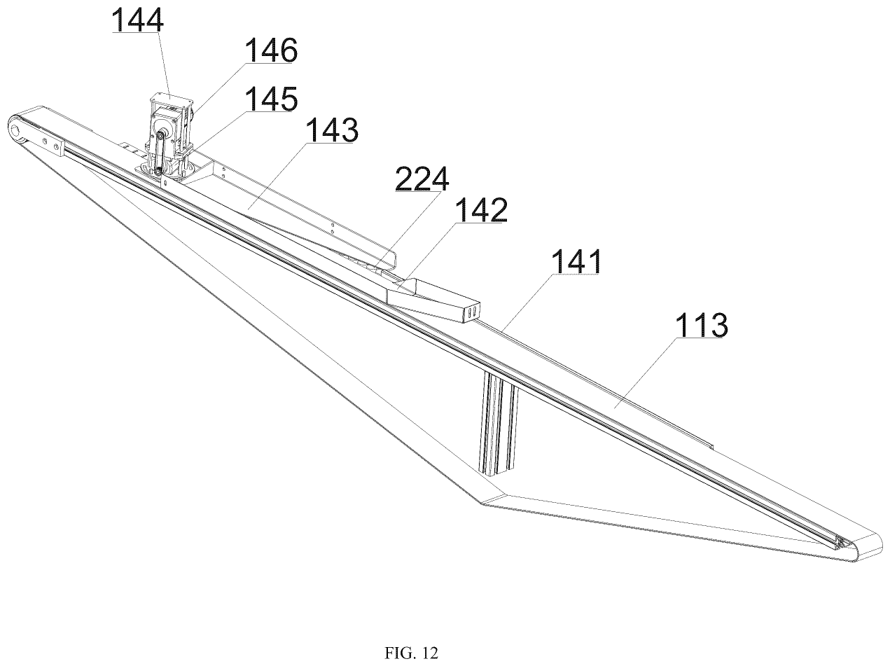

As shown in FIG. 12, the edge-folding mechanism 14 includes an edge-blocking profile 141 disposed on an outer side edge of the conveyor belt support 111 on the outer side, an edge-blocking plate 142 disposed above the conveyor belt 113 to be fixed relative to the fixed side plate 16, and an edge-folding guide plate 143 disposed on the fixed side plate 16, wherein an inner side edge of the edge-folding guide plate 143 is a bevel edge, the bevel edge extends from an outer side of the edge-blocking profile 141 above the edge-blocking plate 142, the edge-blocking profile 141 extends along the conveying direction and gradually increases in height from rear to front, and a maximum height of the edge-blocking profile 141 is higher than an upper surface of the edge-folding guide plate 143. Specifically, a first gap for the vacuum heat-insulating plate a to pass through is formed between the edge-blocking plate 142 and the conveyor belt 113, a second gap for the packaging bag to pass through is formed between the edge-blocking profile 141 and the edge-blocking plate 142, and a third gap for the packaging bag to pass through is formed between the edge-folding guide plate 143 and the edge-blocking plate 142.

As shown in FIG. 12, the edge-folding guide plate 143 is provided with a first support 144 positioned in front of the edge-blocking plate 142, the first support 144 is provided with a first pressing wheel 145 rotatable around a center line thereof and a third motor 146 for driving the first pressing wheel 145 to rotate, and an axis of the first pressing wheel 145 is parallel to a plane on which the conveyor belt 113 is positioned. The packaging bag folded inwards is flattened by the first pressing wheel 145, so that the packaging bag is attached to the vacuum heat-insulating plate a. After the packaging bag is folded inwards by the edge-folding mechanism 14, the edge is further pressed by the first pressing wheel 145, so as to ensure the flatness of the folded vacuum heat-insulating plate a.

As shown in FIG. 11, upper pressing mounting plates 21 extending horizontally along the conveying direction are fixed on the two optical axes 17, a plurality of pressing wheel assemblies are disposed on the upper pressing mounting plates 21, and the plurality of pressing wheel assemblies are uniformly disposed along the conveying direction. Pressure is applied to the vacuum heat-insulating plate a by the pressing wheel assemblies to facilitate upward folding of the packaging bags on the two sides of the vacuum heat-insulating plate a.

As shown in FIG. 11, the pressing wheel assembly includes a second support 221 and a second pressing wheel 222 rotatably disposed on the second support 221, wherein the second pressing wheel 222 extends along the conveying direction perpendicular to the conveyor belt 113, namely extends horizontally along a left-right direction, and the second support 221 is in floating connection with the upper pressing mounting plates 21.

As shown in FIG. 11, two guide rods 223 parallel to each other are fixed on the second support 221, the upper pressing mounting plates 21 are provided with guide holes formed in one-to-one correspondence with the guide rods 223, and the guide rods 223 are in sliding fit with the corresponding guide holes.

As shown in FIG. 12, a mounting plate is mounted on an outer side edge of the conveyor belt support 111 positioned on the outer side, a plurality of guide wheels 224 uniformly distributed along the conveying direction are mounted on the mounting plate, and axes of the plurality of guide wheels 224 extend along a vertical direction.

As shown in FIG. 11, sliding seats 23 are respectively disposed at two ends of the fixed side plates 16, the sliding seats 23 are in sliding fit with second sliding rails 24 disposed on the second frame 15, and the second frame 15 is provided with a height adjustment assembly for adjusting upper and lower heights of the fixed side plates 16. The height of the fixed side plate 16 may be adjusted according to the thickness of the vacuum heat-insulating plate a.

As shown in FIG. 11, the height adjustment assembly includes a top plate 251 fixed on the second frame 15, a second screw 252 rotatably fitted with the top plate 251, and a third hand wheel 253 disposed on the second screw 252, wherein a lower end of the second screw 252 is in threaded connection with the fixed side plates 16. The second screw 252 is in axial limiting connection with the top plate 251, and according to actual situations, four top plates 251 may be disposed and are respectively positioned at four corners of the second frame 15, one second screw 252 is rotatably connected to each top plate 251, and a lower end of each second screw 252 is in threaded connection with the fixed side plate 16. The height of the fixed side plate 16 may be adjusted by rotating the third hand wheel 253.

During work, the vacuum heat-insulating plate a which is subjected to edge-pulling is conveyed between two edge-blocking profiles 141 by the conveyor belt 113, the packaging bags on the two sides of the vacuum heat-insulating plate a are gradually folded upwards under the action of the edge-blocking profiles 141, pressure is applied to the vacuum heat-insulating plate a by the second pressing wheel 222 on the pressing wheel assembly to further fold the packaging bags on the two sides of the vacuum heat-insulating plate a upwards, after the vacuum heat-insulating plate a passes through the edge-blocking plate 142, the packaging bags on the two sides of the vacuum heat-insulating plate a are in contact with a bevel edge of the edge-folding guide plate 143, and begin to be folded inwards, and edges of the packaging bags of the vacuum heat-insulating plate a folded inwards is further pressed by the first pressing wheel 145, so as to ensure the flatness of the folded vacuum heat-insulating plate a.

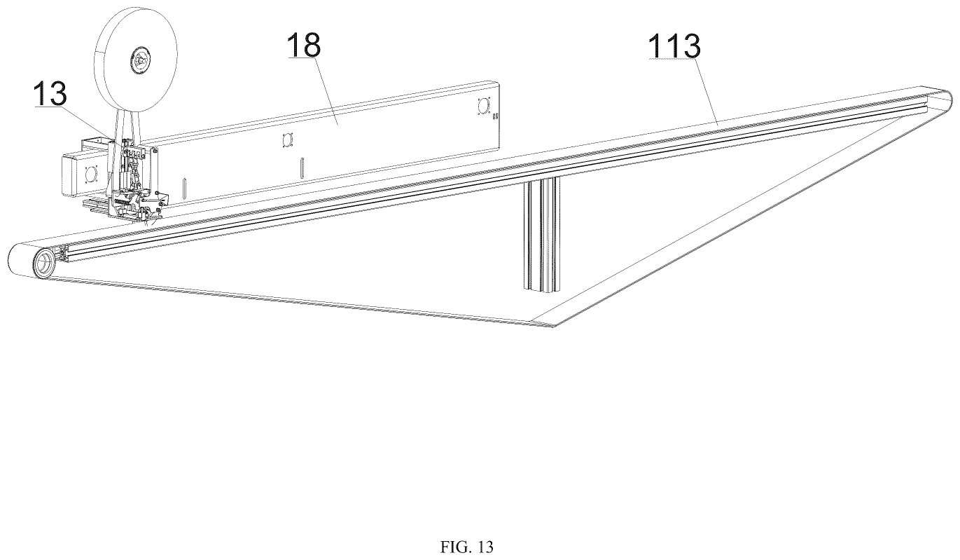

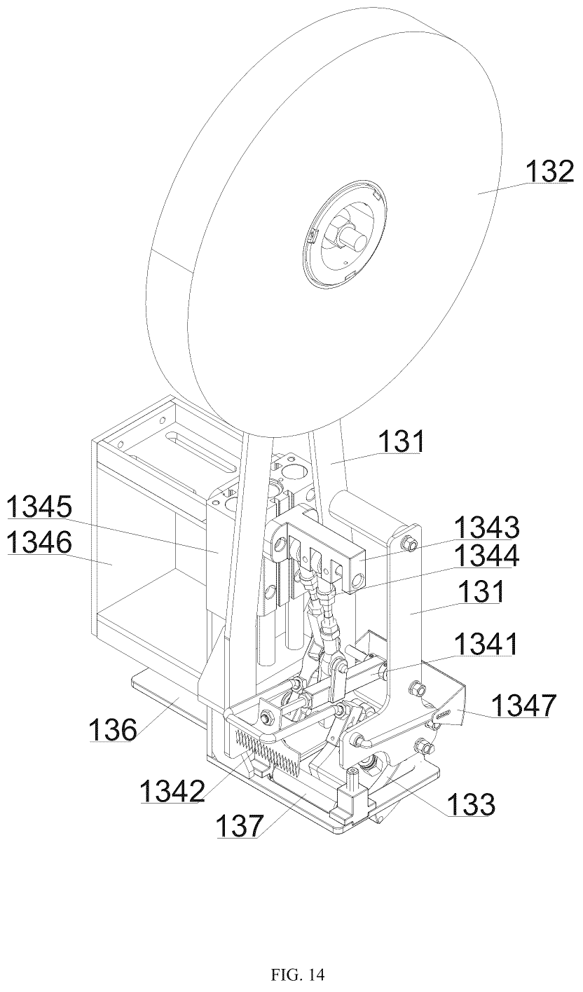

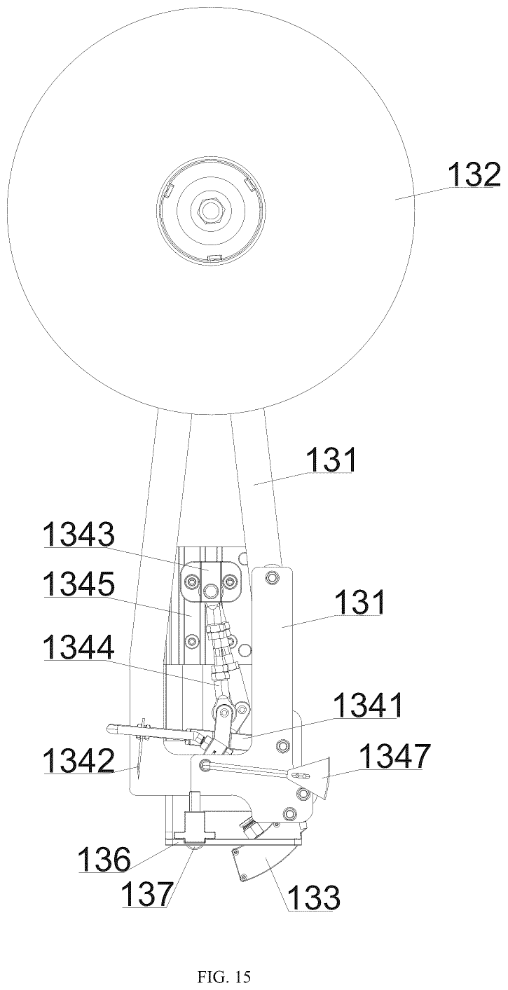

As shown in FIG. 13, the adhesive tape machines 13 are disposed on the adjustment plates 18. As shown in FIG. 14 and FIG. 15, the adhesive tape machine 13 includes a mounting rack 131 disposed above the conveying mechanism 11, an adhesive tape wheel 132 disposed on the mounting rack 131, and a sucker 133 for sucking an adhesive tape, wherein an axis of the adhesive tape wheel 132 extends along a width direction of the first frame 10, the adhesive tape led out by the adhesive tape wheel 132 passes around the sucker 133 from rear to front to be adhered to the vacuum heat-insulating plate a, and the mounting rack 131 is provided with a cutting assembly for cutting the adhesive tape positioned between the sucker 133 and the vacuum heat-insulating plate a, wherein the conveying mechanism 11 extends along a length direction of the first frame 10, a back surface of the adhesive tape led out by the adhesive tape wheel 132 passes around the sucker 133 from rear to front, and an adhesive surface of the adhesive tape is adhered to an upper surface of the vacuum heat-insulating plate a. The vacuum heat-insulating plate a is conveyed forwards to continuously pull the adhesive tape to move forwards, and the adhesive tape is continuously adhered to the vacuum heat-insulating plate a, so as to achieve the purpose of automatically adhering the adhesive tape.

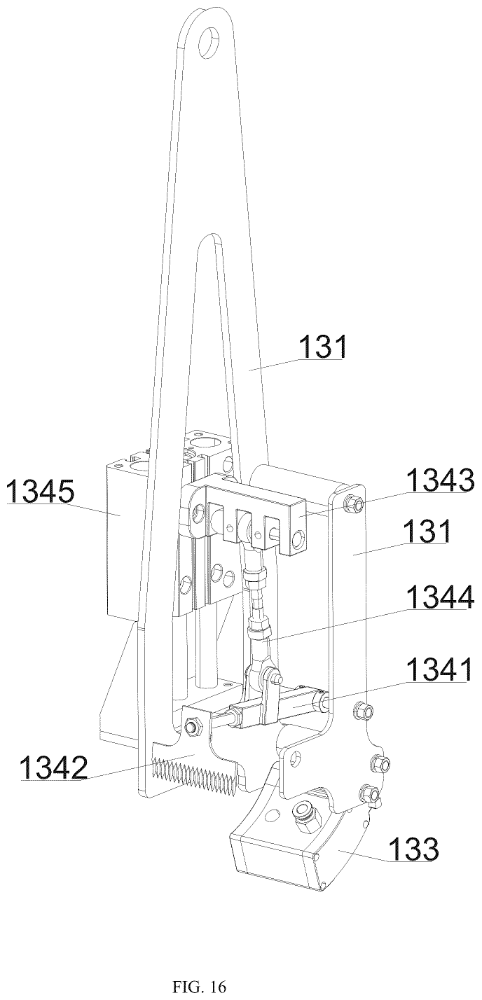

As shown in FIG. 16, the cutting assembly includes a second connecting rod 1341, wherein one end of the second connecting rod 1341 is provided with a blade 1342, and the other end thereof is hinged to the mounting rack 131, and a middle portion of the second connecting rod 1341 is provided with a driving structure for enabling the blade 1342 to cut downwards, wherein the blade 1342 is disposed perpendicular to a length direction of the second connecting rod 1341, and when the second connecting rod 1341 is in a horizontal state, the blade 1342 extends perpendicularly downwards. When the adhesive tape needs to be cut, the driving structure drives the second connecting rod 1341 to rotate, so as to move the blade 1342 downwards, and the blade 1342 is in contact with and cuts the adhesive tape positioned between the sucker 133 and the vacuum heat-insulating plate a.

As shown in FIG. 16, the driving structure includes a transverse support 1343 disposed above the second connecting rod 1341, a first connecting rod 1344 having an upper end hinged to the transverse support 1343, and a lifter 1345 for lifting the mounting rack 131 up and down relative to the transverse support 1343, wherein the first connecting rod 1344 is parallel to an axis of the adhesive tape wheel 132 around a rotation center line of the transverse support 1343, and a lower end of the first connecting rod 1344 is hinged to the middle portion of the second connecting rod 1341, wherein the lifter 1345 drives the mounting rack 131 to lift up and down, so as to drive one end of the second connecting rod 1341 away from the blade 1342 to move up and down, and when one end of the second connecting rod 1341 away from the blade 1342 moves up under the action of the lifter 1345, the blade 1342 moves downwards to complete a cutting motion. Or the lifter 1345 drives the transverse support 1343 to lift up and down, so as to drive the middle portion of the second connecting rod 1341 to move up and down, and when the middle portion of the second connecting rod 1341 moves downwards under the action of the lifter 1345, the blade 1342 moves downwards to complete the cutting motion.

In this example, as shown in FIG. 13 and FIG. 16, a supporting plate 1346 is mounted on the adjustment plate 18, the lifter 1345 includes a cylinder fixed on the supporting plate 1346, the transverse support 1343 is fixed on the cylinder, and the mounting support 131 is fixed on a piston rod of the cylinder. The cylinder is an air cylinder or a hydraulic cylinder, and is the air cylinder in this example. The cylinder is inverted, and the piston rod extends out from a lower end of the cylinder. When the piston rod extends out, the mounting rack 131 is driven to descend; and when the piston rod contracts, the mounting rack 131 is driven to rise.

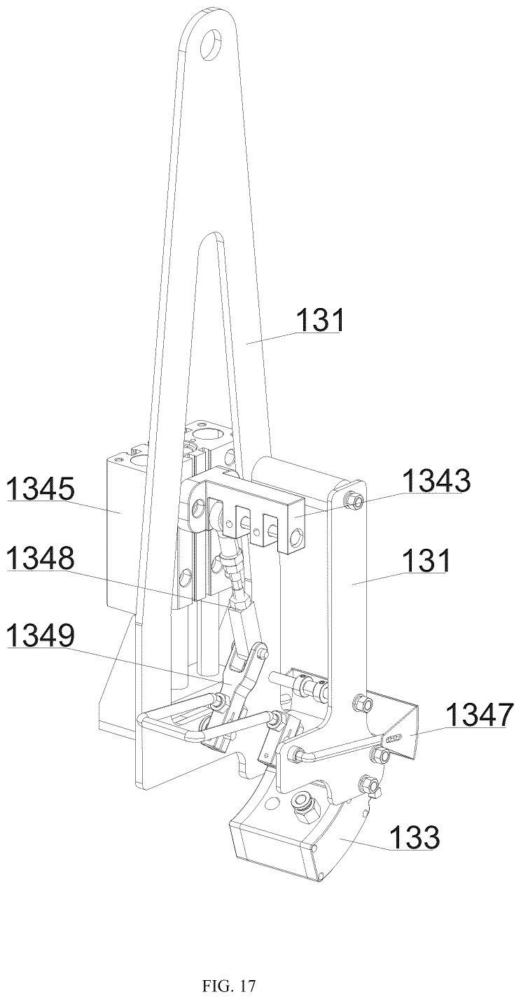

As shown in FIG. 16 and FIG. 17, an upper end of the sucker 133 is hinged to the mounting rack 131, a rotation center of the sucker 133 rotating around the mounting rack 131 is parallel to the axis of the adhesive tape wheel 132, the sucker 133 has a suction surface in contact with the adhesive tape, and the suction surface is provided with a plurality of suction holes, wherein the suction surface is a cylindrical surface or an arc-shaped surface.

The sucker 133 is internally hollow, one side opposite to the suction surface is provided with a gas suction port and a gas inlet, the gas suction port is connected to an external gas pumping apparatus, and the gas inlet is formed to effectively prevent the sucker 133 from sucking the adhesive tape too tightly, and ensure that the adhesive tape may move together with the vacuum heat-insulating plate a. As the mounting rack 131 is lifted up and down, the sucker 133 has two states: in contact with or not in contact with the vacuum heat-insulating plate a.

As shown in FIG. 17, the mounting rack 131 is provided with a baffle plate 1347 for preventing the adhesive tape from falling off the sucker 133, one side of the baffle plate 1347 facing the sucker 133 is provided with an anti-adhesive coating, and the mounting rack 131 is provided with a driving structure for driving the baffle plate 1347 to move below the sucker 133 when the mounting rack 131 rises.

After the mounting rack 131 rises, the baffle plate 1347 moves below the sucker 133 under the action of the driving structure, at this moment, one side of the baffle plate 1347 facing the sucker 133 moves to a lower side of the suction surface and is disposed opposite to the suction surface, and the adhesive tape is pressed between the suction surface and one side of the baffle plate facing the sucker, so as to prevent the adhesive tape from falling off the sucker 133. When the mounting rack 131 descends, the baffle plate 1347 is separated from the sucker 133.

As shown in FIG. 17, the driving structure includes a third connecting rod 1348 which is hinged to the transverse support 1343 and extends downwards, and a fourth connecting rod 1349 hinged to a lower end of the third connecting rod 1348, wherein a first rotary shaft 1350 parallel to the adhesive tape wheel 132 is fixedly connected to a lower end of the fourth connecting rod 1349, the first rotary shaft 1350 is rotatably disposed in the mounting rack 131 in a penetrating way, a fifth connecting rod 1351 is fixedly connected to the first rotary shaft 1350, and the baffle plate 1347 is fixedly connected to the fifth connecting rod 1351. A rotation center line rotating around the third connecting rod 1348 is parallel to the first rotary shaft 1350, the first rotary shaft 1350 is parallel to the adhesive tape wheel 132, and when the mounting rack 131 is lifted up and down, up-and-down movement of the mounting rack 131 is converted into swinging movement of the fifth connecting rod 1351 around the first rotary shaft 1350, so as to control the movement of the baffle plate 1347.

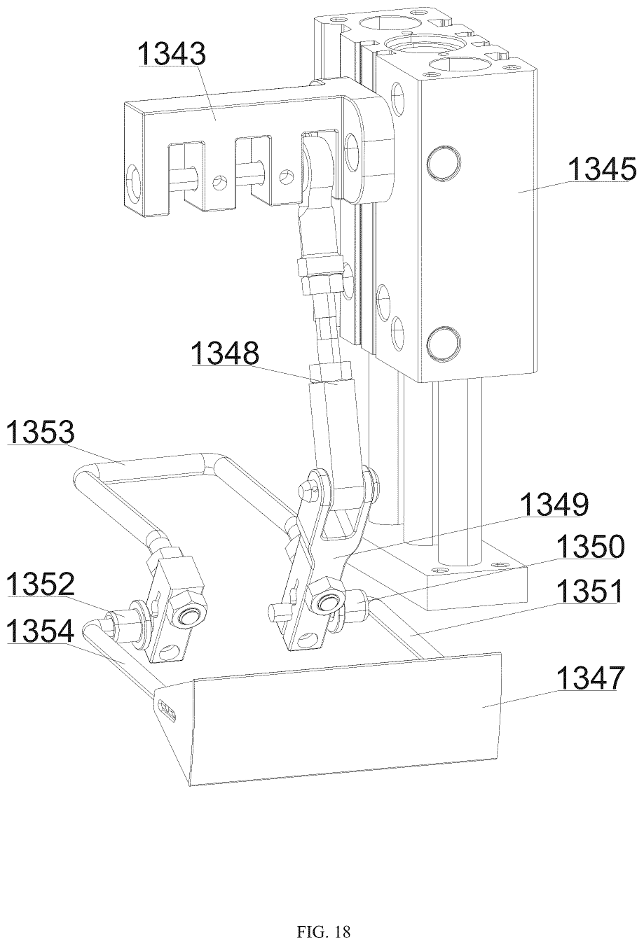

As shown in FIG. 17 and FIG. 18, a second rotary shaft 1352 coaxial with the first rotary shaft 1350 is rotatably disposed on the mounting rack 131 in a penetrating way, the first rotary shaft 1350 is fixedly connected to the second rotary shaft 1352 through a connecting rod 1353, a sixth connecting rod 1354 is fixedly connected to the second rotary shaft 1352, and the baffle plate 1347 is fixedly connected to the sixth connecting rod 1354. One end of the baffle plate 1347 is fixedly connected to the fifth connecting rod 1351, and the other end thereof is fixedly connected to the sixth connecting rod 1354, thereby improving the structural stability of the baffle plate 1347.

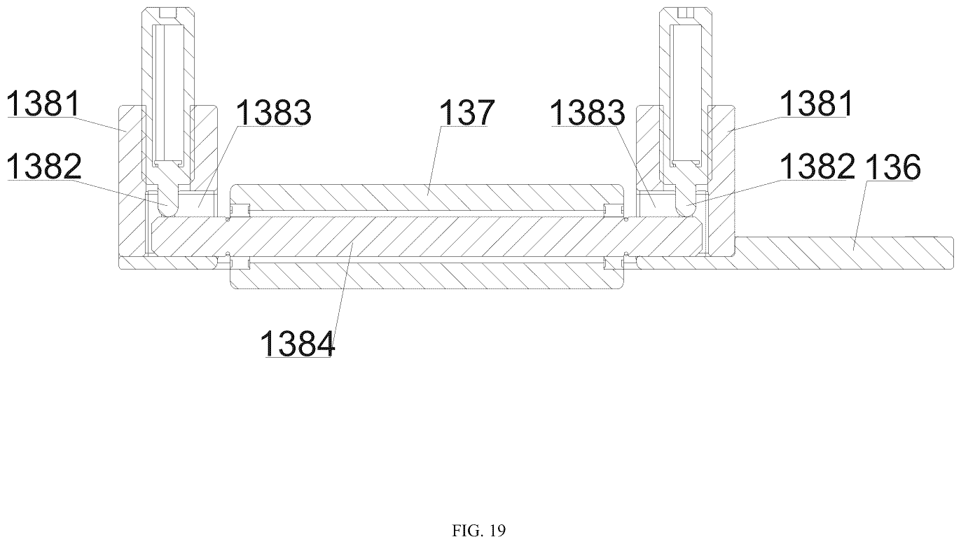

As shown in FIG. 14 and FIG. 15, a bottom plate 136 is fixedly connected below the supporting plate 1346, and as shown in FIG. 19, the bottom plate 136 is provided with an adhesive tape pressing wheel 137 for pressing the adhesive tape on the vacuum heat-insulating plate a and an elastic assembly for always pressing the adhesive tape pressing wheel 137 on the vacuum heat-insulating plate a. The bottom plate 136 is provided with an opening, and the adhesive tape pressing wheel 137 is disposed in the opening. When the sucker 133 is in contact with the vacuum heat-insulating plate a, the sucker 133 is positioned in the opening.

The elastic assembly always presses the adhesive tape pressing wheel 137 on the vacuum heat-insulating plate a, so as to improve an adhering effect of the adhesive tape and the vacuum heat-insulating plate a, and a position of the adhesive tape pressing wheel 137 may be adjusted up and down according to the thickness of the vacuum heat-insulating plate a, so as to enable the adhesive tape to be adhered to the vacuum heat-insulating plates a with different thicknesses. A portion of the adhesive tape positioned between the adhesive tape pressing wheel 137 and the sucker 133 is a tensioned portion in a tensioned state, and when the tensioned portion is cut by the cutting assembly, an avoidance phenomenon of the tensioned portion may not occur.

In this example, the elastic assembly includes two supporting seats 1381 fixed on the bottom plate 136 and elastic members 1382 disposed in the supporting seats 1381 for pressing the adhesive tape pressing wheel 137 downwards, wherein opposite sides of the two supporting seats 1381 are provided with sliding grooves 1383 extending up and down, two ends of a supporting shaft 1384 for supporting the adhesive tape pressing wheel 137 respectively extend into the sliding grooves 1383, and a lower end of the elastic member 1382 acts on the supporting shaft 1384. The elastic member 1382 may be a spring which is pressed on the supporting shaft 1384 under the action of an elastic force, so that the adhesive tape pressing wheel 137 is always pressed on the vacuum heat-insulating plate a.

The processing apparatus for a vacuum heat-insulating plate is controlled by a controller, a displacement sensor is disposed below the adhesive tape machine 13, when the displacement sensor detects that the vacuum heat-insulating plate a folded inwards is conveyed below the adhesive tape machine 13 by the conveyor belt 113, the controller outputs a control instruction to the air cylinder to drive the piston rod of the air cylinder to extend, the air cylinder drives the mounting rack 131 to move downwards, and the sucker 133 is in contact with the packaging bag of the vacuum heat-insulating plate a, so that the adhesive tape is adhered to the packaging bag of the vacuum heat-insulating plate a. When the displacement sensor detects that a tail end of the vacuum heat-insulating plate a is separated from the sucker 133, the controller outputs a control instruction to the air cylinder to drive the piston rod of the air cylinder to contract, the second connecting rod 1341 rotates to drive the blade 1342 to rotate towards the vacuum heat-insulating plate a, at this moment, the adhesive tape is adhered to the vacuum heat-insulating plate a and sucked by the sucker 133 simultaneously, the adhesive tape is in a tightened state, and the adhesive tape is cut by the blade 1342 swinging downwards. Meanwhile, the fourth connecting rod 1349 rotates in a direction of rotation opposite to that of the second connecting rod 1341, the baffle plate 1347 is driven to rotate by the connecting rod 1353, the sixth connecting rod 1354 and the fifth connecting rod 1351, and then the baffle plate 1347 is driven to move below the sucker 133, so that the adhesive tape is closer to the cylindrical surface of the sucker 133, thereby facilitating the suction of the cut adhesive tape by the gas suction port of the sucker 133, and preventing the adhesive tape from falling.

Experimental methods in the following examples are conventional methods unless otherwise specified; and the used raw materials are conventional raw materials in the art and are commercially available unless otherwise specified.

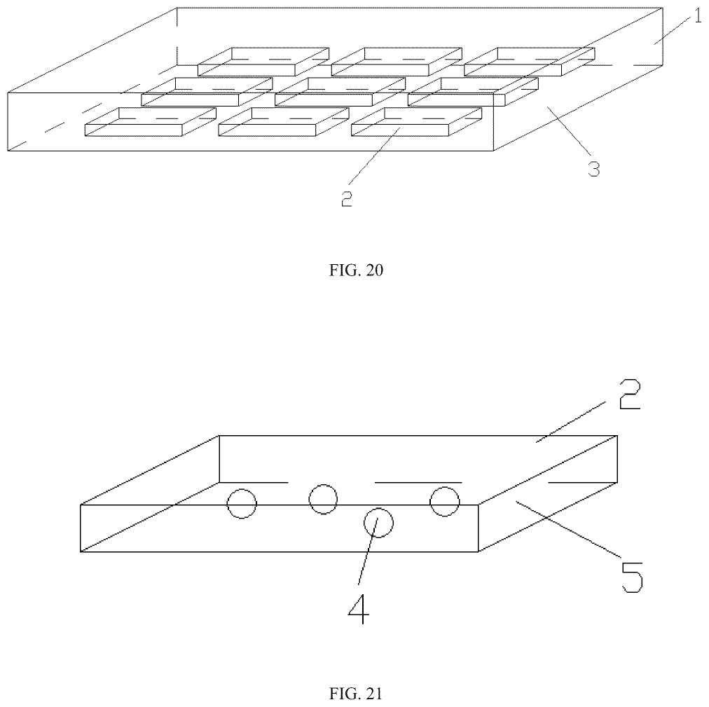

As shown in FIG. 20 and FIG. 21, an aerogel-modified polyurethane foam thermal insulation plate 1 of the present invention includes a polyurethane foam core 3 and at least one thermal insulation pack 2, wherein the thermal insulation pack 2 is disposed inside of the polyurethane foam core 3, polyurethane foam wraps the thermal insulation pack 2, and a volume ratio of the thermal insulation pack 2 in the thermal insulation plate 1 is 10%-90%, preferably 30-70%; the thermal insulation pack 2 includes an outer shell formed by enclosure of a barrier film having a gas barrier effect, the outer shell is filled with a thermal insulation material 5 and at least one gas suction pack 4, the thermal insulation material 5 includes 1-60 wt % of aerogel and 40-99 wt % of an inorganic fiber, preferably 15-60 wt % of aerogel and 40-85 wt % of an inorganic fiber, or 25-60 wt % of aerogel and 40-75 wt % of an inorganic fiber; the gas suction pack 4 is filled with metal oxide, the metal oxide includes calcium oxide, a set amount of the gas suction pack 4 is determined according to an area of the thermal insulation pack 2, and the gas suction pack is controlled to be ≤5 g/m²; and a heat conductivity coefficient of the thermal insulation pack 2 is 0.001-0.010 w/m·k.

In some technical solutions, the barrier film is an aluminum foil composite film, preferably a fiberglass cloth/AL/PET/CPE composite film or a fiberglass cloth/AL/PET/NY/CPE composite film; an outer pack body of the gas suction pack is made of a material having waterproof and breathable properties, preferably a high-density polyethylene material, preferably Tyvek DuPont paper; and the outer pack body is filled with the metal oxide; and

in some technical solutions, the metal oxide further includes copper oxide, and cerium oxide; and a mass percentage of the calcium oxide in the metal oxide is 98-99.5%, the balance is the copper oxide and/or the cerium oxide, and the copper oxide and the cerium oxide are mixed in any ratio.

The aerogel, the inorganic fiber, and the gas suction pack are sealed in the outer shell of the thermal insulation pack, and the outer shell is internally vacuumized and sealed to improve a thermal insulation effect; and preferably, the polyurethane foam core is externally compounded with a decorative surface, and preferably, the decorative surface is a film, coated paper, a non-woven fabric, an aluminum film laminated veneer or a stainless steel frame body.

The aerogel is selected from organic aerogel, polyimide aerogel or polyurethane aerogel, preferably silica aerogel; and the inorganic fiber is selected from one or a mixture of some of fiberglass, a basalt fiber and a ceramic fiber; and preferably, the polyurethane foam core contains a flame retardant.

In some technical solutions, the thermal insulation material further includes a black material, and the black material is one or a mixture of some of carbon black, ferric oxide and trititanium pentoxide; a specific surface area of the black material is 10-360 m²/g, preferably 70-150 m²/g; a mass ratio of the black material in the thermal insulation material is 0%-10%, preferably 2-8% or 3-5%; and an average particle size of the black material is ≤10 um.

In some technical solutions, the thermal insulation material further includes other materials, wherein the other materials are selected from expanded perlite, precipitated silica, calcium carbonate, talcum powder or magnesium hydroxide; and

the thermal insulation pack or the gas suction pack is in a shape of a cuboid, a cube, a sphere or a cylinder.

The thermal insulation plate of the present invention has a thickness of 0.6-10 cm, and the thermal insulation pack has a thickness of 0.49-0.98 cm, a heat conductivity coefficient of ≤0.015 w/m·k, a flame spread index of ≤30, and a smoke index of ≤300.

A preparation method for the above aerogel-modified polyurethane foam thermal insulation plate is operated according to the steps of:
1) preparation of a thermal insulation pack: sealing a thermal insulation material and a gas suction pack in a barrier film to prepare the thermal insulation pack;
2) placing the thermal insulation pack in a thermal insulation plate preparation mold;
3) pouring liquid polyurethane foam into the thermal insulation plate preparation mold, and ensuring that the thermal insulation pack is completely wrapped by a foam material, wherein the liquid polyurethane foam contains a flame retardant, and the flame retardant is a halogen flame retardant or a non-halogen flame retardant, preferably phosphotriester, diethyl hydroxyethyl phosphonate, triethyl phosphate, aluminum hydroxide, magnesium hydroxide or molybdenum oxide;
4) hardening and sizing the foam material to form a final product; and
5) decorating the thermal insulation plate, wherein the decorating includes coloring a surface and compounding a decorative surface on the surface, and preferably the decorative surface is a film, coated paper, a non-woven fabric, an aluminum film laminated veneer or a stainless steel frame body.

The aerogel-modified polyurethane foam thermal insulation plate of the present invention is prepared according to the above method, with the raw materials and ratios shown in Table 1, wherein gas suction pack g/m² in Table 1 refers to a mass of the gas suction pack in per square meter of the thermal insulation pack.

Carbon black is adopted as the black materials in Examples 1-6 of the present invention and Comparative Examples 1-4, and the used carbon black has a specific surface area of 80 m²/g and a particle size of 8 um; and silica aerogel is adopted as the aerogel, fiberglass cotton with an average fiber diameter of 3.5 um is adopted as the inorganic fiber, and the gas suction pack contains 98% of calcium oxide, 1% of copper oxide and 1% of cerium oxide.

The prepared thermal insulation plate is prepared into 300 mm×300 mm small plates for testing and detecting product properties, and detection results are shown in Table 1:

The flame spread index and the smoke index are based on ASTM E 84 Test Method for Surface Burning Characteristics of Building Materials, and the heat conductivity coefficient is adopted based on ASTM C 518-2017 Standard Test Method for Steady-State Thermal Transmission Properties by Means of the Heat Flow Meter Apparatus.

TABLE 1

| | | | | | Volume ratio | | | | |
|---|---|---|---|---|---|---|---|---|---|
| | | | | Gas | of thermal | Thickness | Heat | | |
| | Thermal insulation material | | | suction | insulation pack | of thermal | conductivity | Flame | |
| Experimental | Ratio of | Inorganic | Black | pack | in thermal | insulation | coefficient | spread | Smoke |
| group | aerogel % | fiber % | material % | (g/m²) | insulation plate % | plate cm | w/m · k | index | index |
| Example 1 | 5 | 92 | 3 | 3 | 50 | 3 | 0.020 | 25 | 284 |
| Example 2 | 15 | 82 | 3 | 3 | 50 | 3 | 0.019 | 28 | 286 |
| Example 3 | 25 | 71 | 4 | 3 | 50 | 3 | 0.017 | 26 | 289 |
| Example 4 | 35 | 61 | 4 | 3 | 50 | 3 | 0.014 | 24 | 291 |
| Example 5 | 45 | 50 | 5 | 3 | 50 | 3 | 0.01 | 25 | 288 |
| Example 6 | 60 | 40 | 5 | 3 | 50 | 3 | 0.008 | 28 | 293 |
| Comparative | 0 | 0 | 0 | 0 | 0 | 3 | 0.025 | 28 | 294 |
| Example 1 | | | | | | | | | |
| Comparative | 0 | 100 | 0 | 3 | 50 | 3 | 0.021 | 27 | 284 |
| Example 2 | | | | | | | | | |
| Comparative | 45 | 55 | 0 | 3 | 50 | 3 | 0.012 | 27 | 281 |
| Example 3 | | | | | | | | | |
| Comparative | 45 | 50 | 5 | 0 | 50 | 3 | 0.01 | 25 | 285 |
| Example 4 | | | | | | | | | |

When the aerogel in Examples 2-6 is replaced with polyimide aerogel or polyurethane aerogel, or the inorganic fiber is replaced with basalt fiber or ceramic fiber, or the black material is replaced with ferric oxide or trititanium pentoxide, the resulting thermal insulation plate has product properties similar to those in Examples 2-6 in Table 1, with a heat conductivity coefficient of 0.008-0.020 w/m·k.

In the art, it is generally very difficult to change the heat conductivity coefficient of one thermal insulation plate by 0.001 w/m·k, and a change of 0.001 w/m·k is a significant change in the art.

As can be seen from comparison of Comparative Examples 1, 2 and 3 and Examples 1-6, after the thermal insulation pack and the gas suction pack are disposed, the heat conductivity coefficient of the product further decreases, and the thermal insulation performance is better.

As can be seen from comparison of Comparative Example 3 and Example 5, the addition of the black material to the thermal insulation material may further reduce the heat conductivity coefficient.

Comparative Example 4 is compared with Example 5, no gas suction pack is used in Comparative Example 4, the gas suction pack is used in Example 5, and two groups of experimental samples have similar heat conductivity coefficients, flame spread indexes and smoke indexes. The two groups of experimental samples are subjected to aging treatment, and experimental conditions for aging are as follows: samples are placed in an environment at 80° C. with humidity of 65% for 30 days, and it is ensured that a temperature fluctuation range is ±2° C. and a humidity fluctuation range is ±5%.

The heat conductivity coefficients are tested after the aging treatment to compare changes in the heat conductivity coefficients before and after the aging, and results are shown in Table 2:

TABLE 2

| | Heat conductivity | Heat conductivity |
|---|---|---|
| Experimental | coefficient before | coefficient after |
| group | aging w/m · k | aging w/m · k |
| Example 5 | 0.010 | 0.010 |
| Comparative | 0.010 | 0.012 |
| Example 4 | | |

As can be seen from experimental results, the sample of Example 5 containing the gas suction pack has better aging resistance and longer service life than the sample of Comparative Example 4.

The specific examples described herein are merely illustrative of the spirit of the present invention. Various modifications or additions may be made to the specific examples described or the specific examples may be substituted in a similar manner by those skilled in the art without departing from the spirit of the present invention or going beyond the scope as defined by the appended claims.

What is claimed is:

1. A processing apparatus for a vacuum heat-insulating plate, comprising a first frame, a conveying mechanism disposed on the first frame, two edge-pulling mechanisms arranged as mirror images on two sides of the conveying mechanism, two adhesive tape machines arranged as mirror images on the two sides of the conveying mechanism, and at least one edge-folding mechanism disposed above the conveying mechanism, wherein the two edge-pulling mechanisms, the at least one edge-folding mechanism, and the two adhesive tape machines are sequentially arranged along a conveying direction of the conveying mechanism.

2. The processing apparatus for the vacuum heat-insulating plate according to claim 1, wherein the conveying mechanism comprises a conveyor belt support, two first synchronous wheels respectively disposed at two ends of the conveyor belt support, a conveyor belt tightened on the two first synchronous wheels, and a driving assembly for driving the conveyor belt to convey forwards, and the two edge-pulling mechanisms are disposed on the conveyor belt support.

3. The processing apparatus for the vacuum heat-insulating plate according to claim 1, wherein a second frame is disposed on the first frame, two fixed side plates are arranged as mirror images on the second frame, two optical axes are disposed between the two fixed side plates perpendicular to the conveying direction, two adjustment plates arranged as mirror images are in a sliding fit with the two optical axes, the two adjustment plates are positioned between the two fixed side plates, second screw rods parallel to the two optical axes are disposed on the two fixed side plates in a penetrating way, a second hand wheel is disposed at one end of the second screw rods, each of the second screw rods is provided with a third thread section and a fourth thread section, a direction of a rotation of the third thread section is opposite to a direction of a rotation of the fourth thread section, a first adjustment plate of the two adjustment plates is in a threaded connection with the third thread section, a second adjustment plate of the two adjustment plates is in the threaded connection with the fourth thread section, and two of the at least one edge-folding mechanism are arranged as mirror images between a conveyor belt support positioned on an outer side and the two adjustment plates.

4. The processing apparatus for the vacuum heat-insulating plate according to claim 3, wherein the at least one edge-folding mechanism comprises an edge-blocking profile disposed on the conveyor belt support on the outer side, an edge-blocking plate disposed above a conveyor belt to be fixed relative to the two fixed side plates, and an edge-folding guide plate disposed on the two fixed side plates, wherein an inner side edge of the edge-folding guide plate is a bevel edge, the bevel edge extends from the conveying direction to a middle portion of the conveyor belt along an outer side of the conveyor belt, the edge-blocking profile extends along the conveying direction and gradually increases in height from rear to front, and a maximum height of the edge-blocking profile is higher than an upper surface of the edge-folding guide plate.

5. The processing apparatus for the vacuum heat-insulating plate according to claim 4, wherein the edge-folding guide plate is provided with a first support positioned in front of the edge-blocking plate, the first support is provided with a first pressing wheel rotatable around a center line of the first pressing wheel and a third motor for driving the first pressing wheel to rotate, and an axis of the first pressing wheel is parallel to a plane, the conveyor belt is positioned on the plane.

6. The processing apparatus for the vacuum heat-insulating plate according to claim 3, wherein upper pressing mounting plates are fixed on the two optical axes, a plurality of pressing wheel assemblies are arranged at intervals on the upper pressing mounting plates, and the plurality of pressing wheel assemblies are sequentially arranged along the conveying direction.

7. The processing apparatus for the vacuum heat-insulating plate according to claim 6, wherein each of the plurality of pressing wheel assemblies comprises a second support and a second pressing wheel rotatably disposed on the second support, wherein the second pressing wheel extends along the conveying direction perpendicular to a conveyor belt, and the second support is in a floating connection with the upper pressing mounting plates.

8. The processing apparatus for the vacuum heat-insulating plate according to claim 7, wherein two guide rods parallel to each other are fixed on the second support, the upper pressing mounting plates are provided with guide holes formed in a one-to-one correspondence with the two guide rods, and the two guide rods are in the sliding fit with the guide holes.

9. The processing apparatus for the vacuum heat-insulating plate according to claim 3, wherein sliding seats are respectively disposed at two ends of the two fixed side plates, the sliding seats are in the sliding fit with second sliding rails disposed on the second frame, and the second frame is provided with a height adjustment assembly for adjusting an upper height and a lower height of the two fixed side plates.

10. The processing apparatus for the vacuum heat-insulating plate according to claim 9, wherein the height adjustment assembly comprises a top plate fixed on the second frame, a second screw rotatably fitted with the top plate, and a third hand wheel disposed on the second screw, wherein a lower end of the second screw is in the threaded connection with the two fixed side plates.

11. An aerogel-modified polyurethane foam thermal insulation plate, comprising a polyurethane foam core and at least one thermal insulation pack, wherein the at least one thermal insulation pack is disposed inside of the polyurethane foam core, polyurethane foam wraps the at least one thermal insulation pack, and a volume ratio of the at least one thermal insulation pack in the aerogel-modified polyurethane foam thermal insulation plate is 10%-90%;
the at least one thermal insulation pack comprises an outer shell formed by an enclosure of a barrier film having a gas barrier effect, the outer shell is filled with a thermal insulation material and at least one gas suction pack, the thermal insulation material comprises 1 wt %-60 wt % of an aerogel and 40 wt %-99 wt % of an inorganic fiber;
the at least one gas suction pack is filled with a metal oxide, the metal oxide comprises calcium oxide, a set amount of the at least one gas suction pack is determined according to an area of the at least one thermal insulation pack, and the at least one gas suction pack is controlled to be ≤5 g/m²; and
a heat conductivity coefficient of the at least one thermal insulation pack is 0.001 w/m·k-0.010 w/m·k.

12. The aerogel-modified polyurethane foam thermal insulation plate according to claim 11, wherein
the barrier film is an aluminum foil composite film, a fiberglass cloth/AL/PET/CPE composite film, or a fiberglass cloth/AL/PET/NY/CPE composite film;
an outer pack body of the at least one gas suction pack is made of a material having waterproof and breathable properties, a high-density polyethylene material, or Tyvek DuPont paper; and the outer pack body is filled with the metal oxide; and
the metal oxide further comprises copper oxide and cerium oxide; and a mass percentage of the calcium oxide in the metal oxide is 98%-99.5%, a balance is the copper oxide and/or the cerium oxide.

13. The aerogel-modified polyurethane foam thermal insulation plate according to claim 11, wherein
the aerogel, the inorganic fiber, and the at least one gas suction pack are sealed in the outer shell of the at least one thermal insulation pack, and the outer shell is internally vacuumized and sealed to improve a thermal insulation effect; and
the polyurethane foam core is externally compounded with a decorative surface, and the decorative surface is a film, coated paper, a non-woven fabric, an aluminum film laminated veneer, or a stainless steel frame body.

14. The aerogel-modified polyurethane foam thermal insulation plate according to claim 11, wherein
the aerogel is selected from an organic aerogel, a polyimide aerogel, a polyurethane aerogel, or a silica aerogel; and
the inorganic fiber is selected from one or a mixture of some of fiberglass, a basalt fiber, and a ceramic fiber; and the polyurethane foam core contains a flame retardant.

15. The aerogel-modified polyurethane foam thermal insulation plate according to claim 11, wherein
the thermal insulation material further comprises a black material, and the black material is one or a mixture of some of carbon black, ferric oxide, and trititanium pentoxide;
a specific surface area of the black material is 10 m²/g-360 m²/g;
a mass ratio of the black material in the thermal insulation material is 0%-10%; and
an average particle size of the black material is ≤10 um.

16. The aerogel-modified polyurethane foam thermal insulation plate according to claim 11, wherein the thermal insulation material further comprises expanded perlite, precipitated silica, calcium carbonate, talcum powder, or magnesium hydroxide; and
the at least one thermal insulation pack or the at least one gas suction pack is in a shape of a cuboid, a cube, a sphere, or a cylinder.

17. The aerogel-modified polyurethane foam thermal insulation plate according to claim 11, wherein the aerogel-modified polyurethane foam thermal insulation plate has a thickness of 0.6 cm-10 cm, and the at least one thermal insulation pack has a thickness of 0.49 cm-0.98 cm, the aerogel-modified polyurethane foam thermal insulation plate has a heat conductivity coefficient of ≤0.015 w/m·k, and the aerogel-modified polyurethane foam thermal insulation plate has a flame spread index of ≤30, and the aerogel-modified polyurethane foam thermal insulation plate has a smoke index of ≤300.

18. A preparation method for the aerogel-modified polyurethane foam thermal insulation plate according to claim 11, comprising steps of:
1) a preparation of the at least one thermal insulation pack: sealing the thermal insulation material and the at least one gas suction pack in the barrier film to prepare the at least one thermal insulation pack;
2) placing the at least one thermal insulation pack in a thermal insulation plate preparation mold;
3) pouring liquid polyurethane foam into the thermal insulation plate preparation mold, and ensuring the at least one thermal insulation pack to be completely wrapped by a foam material; and
4) hardening and sizing the foam material to form a final product.

19. The preparation method according to claim 18, wherein the liquid polyurethane foam contains a flame retardant, the flame retardant is a halogen flame retardant or a non-halogen flame retardant, and the flame retardant comprises phosphotriester, diethyl hydroxyethyl phosphonate, triethyl phosphate, aluminum hydroxide, magnesium hydroxide, or molybdenum oxide.

20. The preparation method according to claim 18, further comprising step 5) decorating the aerogel-modified polyurethane foam thermal insulation plate, wherein the step of decorating comprises coloring a surface and compounding a decorative surface on the surface, and the decorative surface is a film, coated paper, a non-woven fabric, an aluminum film laminated veneer, or a stainless steel frame body.
